(19) United States
(12) Patent Application Publication
(10) Pub. No.: US 2023/0411843 A1
(43) Pub. Date: Dec. 21, 2023

(54) ELECTROMAGNETIC FLUX CONTROLLING MEMBER AND MANUFACTURING METHOD FOR THE SAME

(71) Applicant: Enplas Corporation, Saitama (JP)

(72) Inventors: Tomohiro SAITO, Saitama (JP); Takayoshi SUGANUMA, Saitama (JP); Takayuki ARAI, Saitama (JP)

(21) Appl. No.: 18/333,583

(22) Filed: Jun. 13, 2023

(30) Foreign Application Priority Data
Jun. 15, 2022 (JP) 2022-096691

(51) Int. Cl. H01Q 3/44

(52) U.S. Cl. CPC H01Q 3/44

(57) ABSTRACT

An electromagnetic flux controlling member includes a first region disposed on a rear side, and configured to allow incidence of electromagnetic waves or to emit to outside electromagnetic waves having travelled inside, and a second region disposed on a front side, and configured to emit to the outside the electromagnetic waves entered from the first region or to allow incidence of electromagnetic waves. The second region includes a plurality of circular parts concentrically disposed in plan view, outer edges of the plurality of circular parts are disposed such that the outer edges of the plurality of circular parts come closer to the rear side with increasing distance from a central axis side, and widths of at least some circular parts adjacent to each other of the plurality of circular parts are the same, and are smaller than a wavelength of the electromagnetic waves.

This application is entitled to the benefit of Japanese Patent Application No. 2022-096691, filed on Jun. 15, 2022, the disclosure of which including the specification, drawings and abstract is incorporated herein by reference in its entirety.

### TECHNICAL FIELD

The present invention relates to an electromagnetic flux controlling member and a manufacturing method for the same.

### BACKGROUND ART

In radio communication, lens antennas are used as a means for transmitting more information over long distances with high efficiency. Lens antennas have functions of controlling the travelling direction of electromagnetic waves such as converting spherical waves to plane waves, and are increasingly used for radio waves with short wavelengths such as quasi-millimeter waves, millimeter waves, and terahertz waves in recent years.

For example, PTL 1 discloses an antenna structure including a motherboard, an antenna array including a plurality of antenna units, and a lens array including a plurality of lens units (lens antennas). The antenna array is disposed on the motherboard, and the lens array is disposed on the antenna array. The lens units are disposed in a manner corresponding to the respective antenna units. The emission surface of the lens unit is a smooth convex surface. The lens unit is formed with a material with a high dielectric constant such as ceramic and glass.

In the antenna structure disclosed in PTL 1, electromagnetic waves are emitted from the antenna array and the travelling direction of the electromagnetic waves is controlled with the lens array so as to increase the antenna gain.

### CITATION LIST

### Patent Literature

PTL 1
U.S. patent Ser. No. 10/992,060

### SUMMARY OF INVENTION

### Technical Problem

The lens unit in the antenna structure disclosed in PTL 1 is formed by injection molding, for example. To slightly modify the shape of the emission surface of the lens unit, it is necessary to modify the entirety of the transfer surface of the metal mold corresponding to the emission surface. This complicates the management of the mold and makes it difficult to adjust the functional characteristics of the emission surface.

In view of this, an object of the present invention is to provide an electromagnetic flux controlling member with which the metal mold can be easily managed, and the functional characteristics of the electromagnetic flux controlling member can be easily adjusted. In addition, another object of the present invention is to provide a manufacturing method for the electromagnetic flux controlling member.

### Solution to Problem

The present invention relates to the following electromagnetic flux controlling member and manufacturing method for the same.

[1] An electromagnetic flux controlling member includes: a first region disposed on a rear side, and configured to allow incidence of electromagnetic waves or to emit to outside electromagnetic waves having travelled inside; and a second region disposed on a front side, and configured to emit to the outside the electromagnetic waves entered from the first region or to allow incidence of electromagnetic waves The second region includes a plurality of circular parts on a second region side concentrically disposed in plan view. Outer edges of the plurality of circular parts on the second region side are disposed such that the outer edges of the plurality of circular parts on the second region side come closer to the rear side with increasing distance from a central axis side. Widths of at least some circular parts adjacent to each other on the second region side among the plurality of circular parts on the second region side are the same, and are smaller than a wavelength of the electromagnetic waves.
[2] In the electromagnetic flux controlling member according to [1], widths of the plurality of circular parts on the second region side other than a circular part on the second region side that is farthest from the central axis among the plurality of circular parts on the second region side are the same.
[3] In the electromagnetic flux controlling member according to [1], widths of the plurality of circular parts on the second region side are within a range equal to or greater than 0.2 mm, and are smaller than 1.1 mm.
[4] In the electromagnetic flux controlling member according to [1] to [3], each of the plurality of circular parts on the second region side includes a ridgeline.
[5] In the electromagnetic flux controlling member according to [1] to [3], the plurality of circular parts on the second region side is disposed such that a difference in height of outer edges of two circular parts on the second region side adjacent to each other among the plurality of circular parts on the second region side increases with increasing distance from the central axis.
[6] In the electromagnetic flux controlling member according to [1] to [5], the first region includes a plurality of circular parts on a first region side concentrically disposed in plan view, and outer edges of the plurality of circular parts on the first region side are disposed such that the outer edges of the plurality of circular parts on the first region side come closer to the rear side with increasing distance from the central axis.
[7] In the electromagnetic flux controlling member according to [6], in plan view, the outer edges of the plurality of circular parts on the second region side and the outer edges of the plurality of circular parts on the first region side overlap each other.
[8] In the electromagnetic flux controlling member according to [6] or [7], an area of a region inside an innermost circular part on the second region side among the plurality of circular parts on the second region side is greater than an area of a region inside an innermost circular part on the first region side among the plurality of circular parts on the first region side.
[9] A manufacturing method for the electromagnetic flux controlling member according to [1] to [8], the method including: forming the plurality of circular parts on the second region side by using a forming mold. The forming mold includes a plurality of forming pieces with a cylindrical shape concentrically disposed, and each of the plurality of forming pieces includes a transfer surface with a circular shape in plan view for forming some of the plurality of circular parts on the second region side.
[10] In the manufacturing method for the electromagnetic flux controlling member according to [9], each of the plurality of forming pieces includes a transfer surface with a circular shape in plan view for forming one of the plurality of circular parts on the second region side.

### Advantageous Effects of Invention

According to the present invention, it is possible to provide an electromagnetic flux controlling member with which the metal mold can be easily managed, and the functional characteristics of the electromagnetic flux controlling member can be easily adjusted.

### BRIEF DESCRIPTION OF DRAWINGS

FIGS. 1A and 1B illustrate a configuration of the electromagnetic flux controlling member of Embodiment 1;

FIGS. 2A and 2B illustrate a configuration of the electromagnetic flux controlling member of Embodiment 1;

FIG. 3 illustrates a configuration of a forming mold;

FIGS. 4A and 4B illustrate a configuration of electromagnetic flux controlling members of Embodiments 2 and 3;

FIG. 5 is a schematic view for describing a configuration of a device for a simulation;

FIGS. 6A and 6B are sectional views of electromagnetic flux controlling members of Comparative Examples 1 and 2;

FIGS. 7A and 7B are sectional views of electromagnetic flux controlling members of Comparative Examples 3 and 4;

FIG. 8 is a sectional view of an electromagnetic flux controlling member of Comparative Example 5;

FIGS. 9A and 9B are graphs illustrating a relationship between the angle with respect to the reference line and the maximum gain;

FIG. 10 is a graph illustrating a relationship between the angle with respect to the reference line and the maximum gain in Embodiment 3;

FIGS. 11A and 11B are graphs illustrating a relationship between the angle with respect to the reference line and the maximum gain in a case where no electromagnetic flux controlling member is used and in Comparative Example 1;

FIG. 12 is a graph illustrating a relationship between the angle with respect to the reference line and the maximum gain in Comparative Example 2;

FIGS. 13A and 13B are graphs illustrating a relationship between the angle with respect to the reference line and the maximum gain in Comparative Example 3 and Comparative Example 4;

FIG. 14 is a graph illustrating a relationship between the angle with respect to the reference line and the maximum gain in Comparative Example 5;

FIGS. 15A and 15B illustrate a configuration of the electromagnetic flux controlling member of Embodiment 4;

FIGS. 16A and 16B illustrate a configuration of the electromagnetic flux controlling member of Embodiment 4;

FIG. 17 illustrates a configuration of a forming mold;

FIGS. 18A and 18B illustrate a configuration of the electromagnetic flux controlling member of Embodiment 5;

FIGS. 19A and 19B illustrate a configuration of the electromagnetic flux controlling member of Embodiment 6;

FIGS. 20A and 20B illustrate a configuration of the electromagnetic flux controlling member of Embodiment 7;

FIGS. 21A and 21B illustrate a configuration of the electromagnetic flux controlling member of Embodiment 8;

FIGS. 22A and 22B illustrate a configuration of the electromagnetic flux controlling member of Embodiment 9;

FIGS. 23A and 23B are graphs illustrating a relationship between the angle with respect to the reference line and the maximum gain in Embodiments 4 and 5;

FIG. 24 is a graph illustrating a relationship between the angle with respect to the reference line and the maximum gain in Embodiment 6;

FIGS. 25A and 25B are graphs illustrating a relationship between the angle with respect to the reference line and the maximum gain in Embodiments 7 and 8;

FIG. 26 is a graph illustrating a relationship between the angle with respect to the reference line and the maximum gain in Embodiment 9;

FIGS. 27A and 27B illustrate a configuration of the electromagnetic flux controlling member of Embodiment 10;

FIGS. 28A and 28B illustrate a configuration of the electromagnetic flux controlling member of Embodiment 10;

FIGS. 29A and 29B illustrate a configuration of the electromagnetic flux controlling member of Embodiment 11;

FIGS. 30A and 30B illustrate a configuration of the electromagnetic flux controlling member of Embodiment 12;

FIGS. 31A and 31B illustrate a configuration of an electromagnetic flux controlling member of a reference example;

FIG. 32 illustrates a configuration of an electromagnetic flux controlling member of a reference example; and

FIG. 33 is a graph illustrating a relationship between the angle with respect to the reference line and the maximum gain in a reference example.

### DESCRIPTION OF EMBODIMENTS

Embodiments according to the present invention are elaborated below with reference to the accompanying drawings.

### Embodiment 1

### Configuration of Electromagnetic Flux Controlling Member

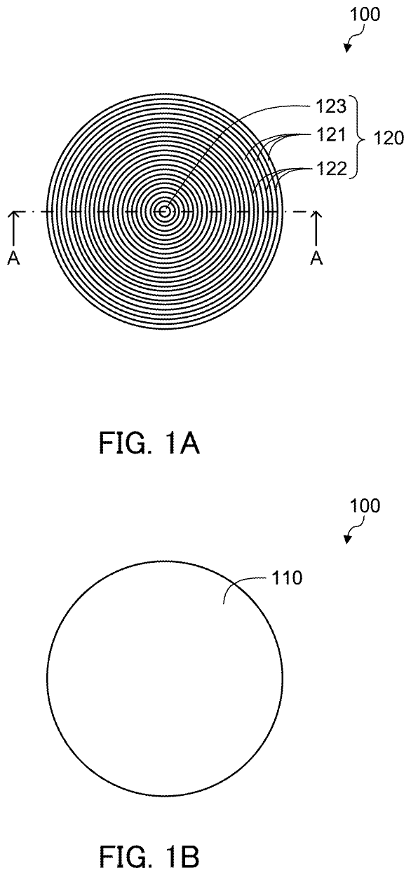

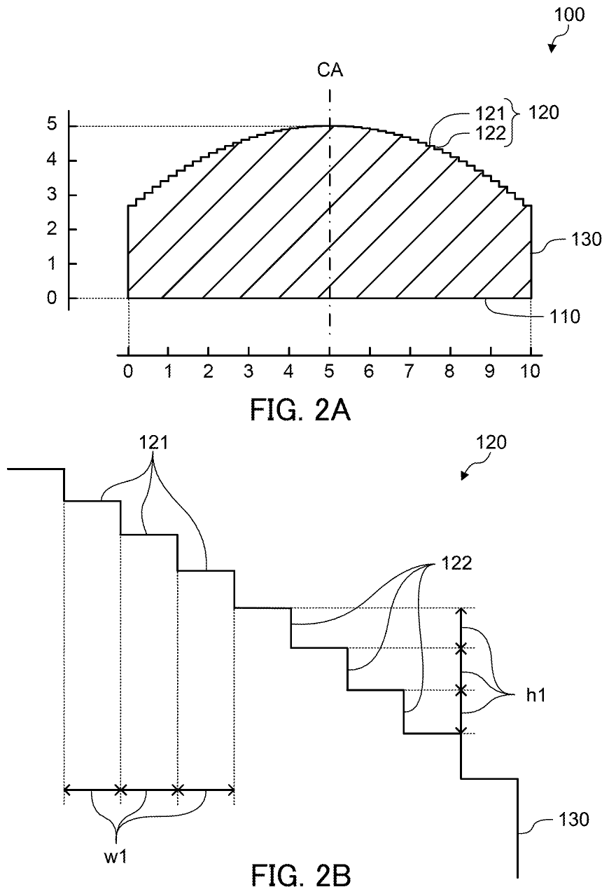

FIG. 1A is a plan view of electromagnetic flux controlling member 100, and FIG. 1B is a bottom view of electromagnetic flux controlling member 100. FIG. 2A is a sectional view taken along line A-A of FIG. 1A, and FIG. 2B is a partially enlarged sectional view of FIG. 2A. Note that in FIG. 2, hatching representing the cross-section is omitted.

As illustrated in FIGS. 1A, 1B, 2A and 2B, electromagnetic flux controlling member 100 includes first region 110 disposed on the rear side, and second region 120 disposed on the front side. Note that in the present embodiment, electromagnetic flux controlling member 100 further includes side surface 130 disposed on the lateral side.

The material of electromagnetic flux controlling member 100 is not limited as long as the effects of the present invention can be achieved, and is appropriately selected from materials that can transmit the electromagnetic waves to be controlled. Examples of the material of electromagnetic flux controlling member 100 include ceramics, resins, and glass. Examples of the resin include polypropylene, polycycloolefin, polytetrafluoroethylene, and modified polyphenylene ether. Preferably, the material of electromagnetic flux controlling member 100 is a material with a high dielectric constant with a relative permittivity of 5 or greater because significant effects can be achieved, for example.

Note that in the present embodiment, electromagnetic flux controlling member 100 is rotationally symmetrical (circularly symmetrical) about central axis CA extending in the front-rear direction as the rotation axis. In addition, in the present embodiment, electromagnetic flux controlling member 100 has a height (thickness) of 5 mm, and a diameter of 10 mm in plan view. In addition, central axis CA is also central axis CA of electromagnetic flux controlling member 100, central axis CA of first region 110, central axis CA of second region 120, and central axis CA of side surface 130.

The type of the electromagnetic waves to be controlled is not limited. Examples of the electromagnetic waves include radio waves such as millimeter waves, quasi-millimeter waves and terahertz waves, visible light beams, and infrared rays. For example, the wavelength of the electromagnetic waves used for electromagnetic flux controlling member 100 of the present embodiment is, but not limited to, within a range of 1 to 10 mm, for example. Note that in the present embodiment, the wavelength of the electromagnetic waves to be used is 1.1 mm or smaller.

First region 110 is a region for allowing incidence of the electromagnetic waves, or a region for emitting to the outside the electromagnetic waves having travelled inside. In the present embodiment, first region 110 is a region for allowing incidence of the electromagnetic waves. First region 110 is disposed to intersect central axis CA of electromagnetic flux controlling member 100.

The shape of first region 110 is not limited as long as it can allow electromagnetic waves to enter electromagnetic flux controlling member 100, and is set as necessary in accordance with the shape of second region 120 and the like. First region 110 may be a flat surface or a recessed surface. In the present embodiment, the shape of first region 110 is rotationally symmetrical (circularly symmetrical) about central axis CA as the rotation axis, and is a flat surface.

Second region 120 is a region for allowing incidence of the electromagnetic waves, or a region for emitting, to the outside of electromagnetic flux controlling member 100, the electromagnetic waves entered from first region 110, while controlling the travelling direction. In the present embodiment, second region 120 is a region for emitting, to the outside of electromagnetic flux controlling member 100, the electromagnetic waves entered from first region 110, while controlling the travelling direction. It is disposed to intersect central axis CA with a convex shape in its entirety. Note that in the present embodiment, the height of second region 120 (the difference between the upper end portion and the lower end portion) is 2.5 mm. In the present embodiment, the shape of second region 120 is rotationally symmetrical (circularly symmetrical) about central axis CA as the rotation axis. Second region 120 includes a plurality of circular parts 121 on second region 120 side. Note that in the present embodiment, second region 120 further includes a plurality of first step surfaces 122, and top surface 123.

The plurality of circular parts 121 is optical surfaces with a circular shape concentrically disposed in plan view. In the present embodiment, circular part 121 emits to the outside a part of the electromagnetic waves entered from first region 110. Circular part 121 may be a flat surface perpendicular to central axis CA or a tilted surface. In the present embodiment, circular part 121 is a flat surface perpendicular to central axis CA. Note that the plurality of circular parts 121 are not surfaces in which the outer edges of adjacent two circular parts 121 are connected by the shortest distance.

The outer edges of the plurality of circular parts 121 are disposed to come closer to the rear side with increasing distance from central axis CA. Specifically, in the present embodiment, the plurality of circular parts 121 is disposed stepwise such that the height of first region 110 decreases with increasing distance from central axis CA. Among the plurality of circular parts 121, widths w1 of at least some circular parts 121 are the same, and are smaller than the wavelength of the electromagnetic waves used. Note that in the present embodiment, widths w1 of all circular parts 121 are the same. Here, width w1 of circular part 121 is the distance between the inner edge and the outer edge of circular part 121 in plan view, i.e., the distance between the inner edge and the outer edge of circular part 121 in the direction perpendicular to central axis CA. Width w1 of circular part 121 is appropriately set in accordance with the wavelength of the electromagnetic waves used. If width w1 of circular part 121 is equal to or greater than the wavelength of the electromagnetic waves used, the antenna gain may possibly be reduced.

Preferably, width w1 of at least some adjacent circular parts 121 is within a range of to 1.0 mm. If width w1 of circular parts 121 is smaller than 0.2 mm, it may be difficult to fabricate forming mold 150 described later. On the other hand, if width w1 of circular parts 121 is greater than 1.0 mm, the antenna gain may possibly be reduced. In the present embodiment, width w1 (pitch) of the plurality of circular parts 121 with a circular shape is 0.2 mm.

The difference in height of the outer edges of adjacent two circular parts 121 in the plurality of circular parts 121 may be the same or different. The difference in height of the outer edges of adjacent two circular parts 121 may be set to increase with increasing distance from central axis CA or may be set to decrease with increasing distance from central axis CA. Preferably, the difference in height of the outer edges of adjacent two circular parts 121 in the plurality of circular parts 121 is set to increase with increasing distance from central axis CA. Note that in the present embodiment, the difference in height of the outer edges of adjacent two circular parts 121 is the same as height h1 of first step surface 122.

First step surface 122 is a curved surface disposed to surround central axis CA, and connects adjacent two circular parts 121. Respective circular parts 121 are connected to the upper end and lower end of first step surface 122. The shape of first step surface 122 is not limited as long as the above-mentioned function can be ensured. The shape of first step surface 122 may be a shape of the side surface of a column, a shape of the side surface of a truncated cone, or a shape of the side surface of an inverted truncated cone. Preferably, the shape of first step surface 122 is a shape of the side surface of a column. Specifically, first step surface 122 may be parallel to central axis CA, or tilted to central axis CA. In the present embodiment, first step surface 122 is parallel to central axis CA from the viewpoint of the ease of the processing. That is, in the present embodiment, circular part 121 and first step surface 122 are perpendicularly connected. In the present embodiment, height h1 of first step surface 122 is set to increase in the direction from the front side (center portion) toward the rear side (side surface side) of electromagnetic flux controlling member 100.

Height h1 of first step surface 122 is appropriately set in accordance with the control characteristics of the electromagnetic waves to be applied to second region 120. In the case where the second region is composed of a smooth curved surface as with the known electromagnetic flux controlling member, the preferable shape of the second region may be determined through simulations and the like. Also in second region 120 of electromagnetic flux controlling member 100 according to the present embodiment, the plurality of circular parts 121 may be disposed near that preferable curved surface such that the control characteristics close to those of the preferable shape of the second region composed of the smooth curved surface determined as described above can be achieved. For example, height h1 of the plurality of first step surfaces 122 is defined as follows. First, width w1 of circular part 121 is set. Next, in the cross section including central axis CA, the plurality of circular parts 121 is disposed with the middle point located on the curve representing the ideal shape of second region 120. Here, the distances between adjacent two circular parts 121 are the same in the direction perpendicular to central axis CA. Finally, the plurality of first step surfaces 122 are disposed to connect the plurality of respective circular parts 121.

Side surface 130 is a curved surface disposed to surround central axis CA, and connect the outer edge of first region 110 and the outer edge of second region 120. The shape of side surface 130 is not limited. In the present embodiment, the shape of side surface 130 is a shape of the side surface of a column. In side surface 130, the lower end portion (rear side) is connected to first region 110, and the upper end portion (front side) is connected to second region 120. In the present embodiment, the height (the difference between the upper end portion and the lower end portion) of side surface 130 is 2.5 mm. Note that electromagnetic flux controlling member 100 may not include side surface 130. In this case, first region 110 and second region 120 are directly connected to each other.

Top surface 123 is an optical surface disposed in the region on the inside than innermost circular part 121 in second region 120. The shape of top surface 123 is not limited. The shape of top surface 123 may be a flat surface or a convex surface. In the present embodiment, top surface 123 is a flat surface. In addition, in the present embodiment, circular part 121 is a surface perpendicular to central axis CA. Top surface 123 emits to the outside a part of the electromagnetic waves entered from first region 110. In the present embodiment, the diameter of top surface 123 in plan view is 0.4 mm.

### Forming Mold

The manufacturing method of electromagnetic flux controlling member 100 according to the present embodiment is not limited. For example, electromagnetic flux controlling member 100 according to the present embodiment can be manufactured by injection molding.

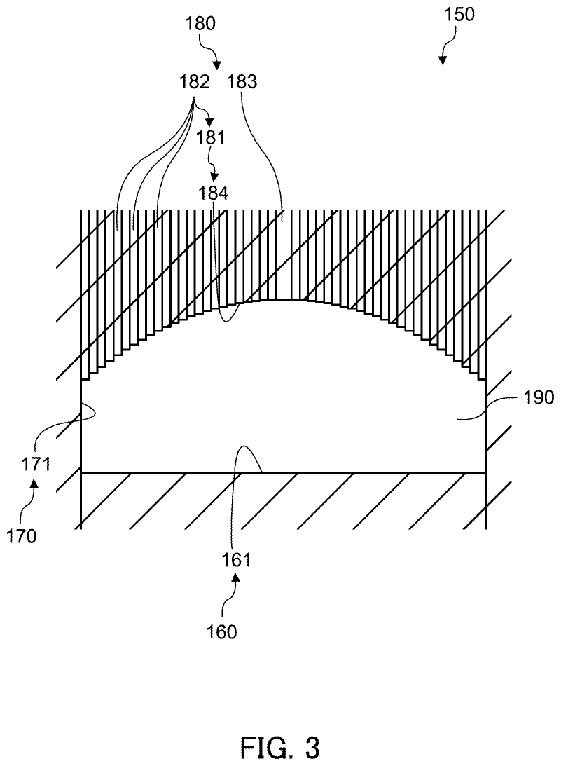

FIG. 3 is a sectional view of forming mold 150 for forming electromagnetic flux controlling member 100. Forming mold 150 forms cavity 190 with a shape complementary to electromagnetic flux controlling member 100.

The material of forming mold 150 is not limited as long as a rigidity with which electromagnetic flux controlling member 100 can be formed with the forming material provided thereto, and may be appropriately selected from publicly known materials. Examples of the material of forming mold 150 include metal.

In the present embodiment, forming mold 150 includes first forming mold 160, second forming mold 170, and third forming mold 180.

First forming mold 160 is a piece for forming first region 110. First forming mold 160 includes first transfer surface 161 with a shape complementary to first region 110. In the present embodiment, first region 110 is a flat surface, and therefore first transfer surface 161 is a flat surface. The number of the pieces of first forming mold 160 is one, or more. In the present embodiment, one first forming mold 160 is provided.

Second forming mold 170 is a piece for forming side surface 130 of electromagnetic flux controlling member 100. Second forming mold 170 includes second transfer surface 171 with a shape complementary to side surface 130 of electromagnetic flux controlling member 100. In the present embodiment, side surface 130 has a shape of the side surface of a column, and therefore second transfer surface 171 has a shape of the side surface of a column. The number of the pieces of second forming mold 170 may be one, or more. In the present embodiment, one second forming mold 170 is provided.

Third forming mold 180 is a piece for forming second region 120. Third forming mold 180 includes third transfer surface 181 with a shape complementary to second region 120 of electromagnetic flux controlling member 100. Third transfer surface 181 includes a surface corresponding to the plurality of circular parts 121, and a surface corresponding to the plurality of first step surfaces 122, and a surface corresponding to top surface 123. In addition, third forming mold 180 includes a plurality of third forming pieces 182 (the forming piece in claims) for forming circular part 121 and first step surface 122, and fourth forming piece 183 for forming top surface 123.

The plurality of third forming pieces 182 is concentric cylindrical pieces. Each third forming piece 182 may include transfer surface 184 with a circular shape in plan view for forming some of the plurality of circular parts 121, and a transfer surface with a circular shape in plan view for forming one of the plurality of circular parts 121. In the present embodiment, each of the plurality of third forming pieces 182 includes transfer surface 184 with a circular shape in plan view for forming one of the plurality of circular parts 121. Therefore, in the present embodiment, the number of third forming pieces 182 is the same as the number of circular parts 121 to be formed. The width of transfer surface 184 of third forming piece 182 is the same as the width of circular part 121. Specifically, in the present embodiment, the width of transfer surface 184 is 0.2 mm. In the case where third forming piece 182 is provided with one transfer surface 184, the number of the surfaces corresponding to first step surface 122 is one. In the case where third forming piece 182 is provided with a plurality of transfer surfaces 184, a plurality of surfaces corresponding to the plurality of first step surfaces 122 is provided.

In the present embodiment, the plurality of third forming pieces 182 is disposed such that respective transfer surfaces come closer to first transfer surface 161 side as it goes from the center portion toward the outer periphery portion. The shape of second region 120 can be easily designed and modified by changing the shape of third transfer surface 181 by changing the positions of the plurality of third forming pieces 182.

Fourth forming piece 183 is a columnar piece disposed inside the innermost third forming piece 182. The top surface of the column is the surface corresponding to top surface 123. The size of the top surface of the column corresponds to the size of top surface 123. In the present embodiment, the diameter of the top surface of the column is 0.4 mm.

### Forming Procedure

An example of a forming procedure of electromagnetic flux controlling member 100 is described below.

First, forming mold 150 is prepared. More specifically, first forming mold 160, second forming mold 170 and third forming mold 180 are fixed to predetermined positions. Next, a forming material is injected to cavity 190 formed of first forming mold 160, second forming mold 170 and third forming mold 180. At this time, the gas generated from the air and forming material in cavity 190 is discharged from the boundary between the plurality of third forming pieces 182. In this manner, electromagnetic flux controlling member 100 is formed in accordance with forming mold 150.

Next, the forming material is solidified through pressure holding and cooling. Next, first forming mold 160, second forming mold 170 and third forming mold 180 are opened to remove formed electromagnetic flux controlling member 100. In this manner, electromagnetic flux controlling member 100 can be obtained. Note that the shape of second region 120 can be modified by changing the arrangement of third forming mold 180.

### Effects

According to the present embodiment, electromagnetic flux controlling member 100 that can be manufactured with high yield can be provided while maintaining the function of electromagnetic flux controlling member 100. In addition, second region 120 in electromagnetic flux controlling member 100 of the present embodiment is formed with the plurality of concentric cylindrical third forming pieces 182, and thus the design can be easily changed.

### Embodiments 2 and 3

Next, electromagnetic flux controlling members 200 and 300 of Embodiments 2 and 3 are described. Electromagnetic flux controlling members 200 and 300 of Embodiments 2 and 3 differ from electromagnetic flux controlling member 100 of Embodiment 1 in the shapes of second regions 220 and 320. In view of this, the same components as those of electromagnetic flux controlling member 100 of Embodiment 1 are denoted with the same reference numerals, and the description thereof will be omitted.

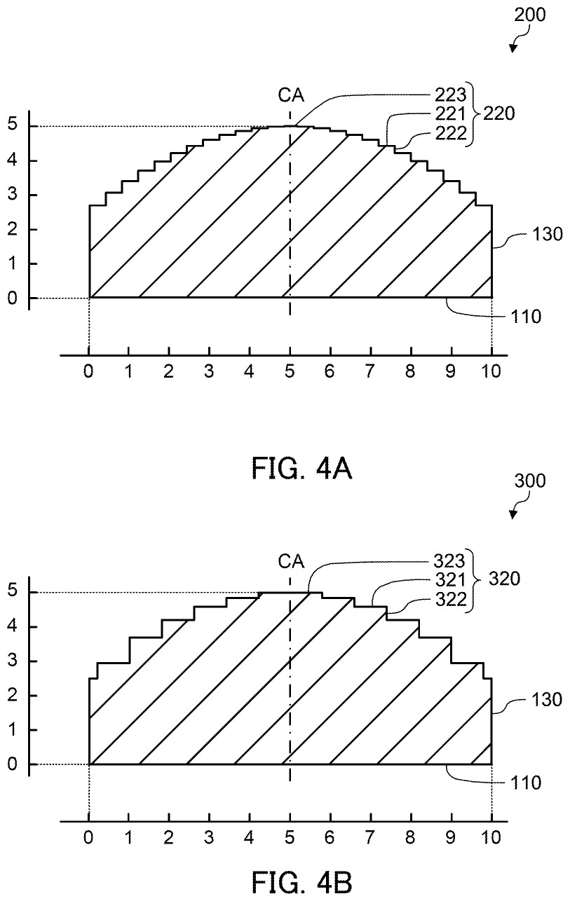

FIG. 4A is a sectional view of electromagnetic flux controlling member 200 of Embodiment 2, and FIG. 4B is a sectional view of electromagnetic flux controlling member 300 of Embodiment 3.

As illustrated in FIG. 4A, electromagnetic flux controlling member 200 of Embodiment 2 includes first region 110 and second region 220. In the present embodiment, electromagnetic flux controlling member 200 further includes side surface 130.

Second region 220 of the present embodiment includes a plurality of circular parts 221, a plurality of first step surfaces 222, and top surface 223. Circular part 221 is optical surfaces with a circular shape concentrically disposed in plan view. The outer edges of the plurality of circular parts 221 are disposed to come closer to the rear side with increasing distance from central axis CA. In the present embodiment, the distances (pitch) between the outer edges of circular parts 221 adjacent to each other are the same, i.e., 0.4 mm, and are smaller than the wavelength of the electromagnetic waves. In addition, top surface 223 is a flat surface with a diameter of 0.4 mm.

Height h1 of first step surface 222 is set to increase in the direction from the front side (center portion) toward the rear side (side surface side) of electromagnetic flux controlling member 200. The method of setting first step surface 222 is the same as the method for first step surface 222 of Embodiment 1.

### Effects

Electromagnetic flux controlling member 200 of Embodiment 2 has an effect similar to that of electromagnetic flux controlling member 100 of Embodiment 1.

As illustrated in FIG. 4B, electromagnetic flux controlling member 300 of Embodiment 3 includes first region 110 and second region 320. In the present embodiment, electromagnetic flux controlling member 300 further includes side surface 130.

Second region 320 of the present embodiment includes a plurality of circular parts 321, a plurality of first step surfaces 322, and top surface 323. Second region 320 includes the plurality of circular parts 321 with a circular shape concentrically disposed in plan view. The outer edges of the plurality of circular parts 321 are disposed to come closer to the rear side with increasing distance from central axis CA. Widths w1 of at least some of the plurality of circular parts 321 are the same, and are smaller than the wavelength of the electromagnetic waves used. In the present embodiment, the distance (pitch) between the outer edges of circular parts 321 adjacent to each other is 0.8 mm, and width w1 of the outermost circular part 321 is mm. In addition, the diameter of top surface 323 is 1.6 mm.

Preferably, height h1 of first step surface 322 is set to increase in the direction from the front side (center portion) toward the rear side (side surface side) of electromagnetic flux controlling member 300. Note that height h1 of the outermost first step surface 322 may be smaller than height h1 of first step surface 322 at the center.

### Effects

Electromagnetic flux controlling member 300 of Embodiment 3 has an effect similar to that of electromagnetic flux controlling member 100 of Embodiment 1.

### Simulations

Next, the relationships of the angle with respect to reference line, the maximum gain and the maximum gain power were examined by using electromagnetic flux controlling members 100 to 300 of Embodiments 1 to 3.

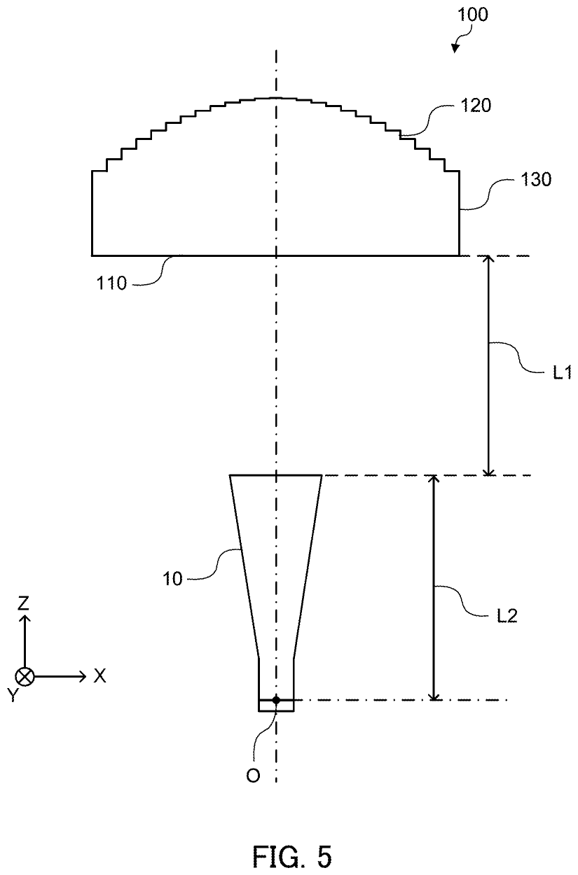

FIG. 5 is a schematic view for describing a configuration of a device for a simulation. Here, as an example case where electromagnetic flux controlling member 100 is used is described. As illustrated in FIG. 5, distance L1 between electromagnetic flux controlling member 100 and horn antenna 10 is 10 mm. The size of the upper opening of horn antenna 10 is 2.5 mm long×1.8 mm wide, and the size of the lower opening is 0.9 mm long×0.4 mm wide, with length L2 of 6 mm. In this simulation, the upper opening and the lower opening both have rectangular shapes. In addition, in this simulation, the radio wave source was disposed 1 mm above the lower opening of horn antenna 10.

The radio wave source center was set to 0, the direction along the axis of horn antenna 10 (the up-down direction in FIG. 5) from center O of the radio wave source was set to the Z direction, the direction (the left-right direction in FIG. 5) perpendicular to the Z direction was set to the X direction, and the direction (the front-rear direction in FIG. 5) perpendicular to the Z direction and the X direction was set to the Y direction. The straight line passing through center O of the radio wave source and extending along the Z direction is set to the reference line. Electromagnetic flux controlling member 100 has a diameter of 10 mm and a height of 5 mm. The material of electromagnetic flux controlling member 100 was polypropylene. The electromagnetic wave analysis was performed through a multi level fast multipole method (MLFMM). In the analysis result, the antenna gain Gd in the far field was represented by dBi. The frequency of the electromagnetic waves was set to 270 GHz, and the wavelength was set to 1.1 mm.

The relationship between the angle in the XZ plane where the direction (the Z direction) along the reference line is set to 0°, and the antenna gain was examined. In addition, the relationship between the angle in the YZ plane where the direction (the Z direction) along the reference line is set to 0°, the maximum gain and the maximum gain power was examined. As the electromagnetic flux controlling member, electromagnetic flux controlling member 100 of Embodiment 1, electromagnetic flux controlling member 200 of Embodiment 2, or electromagnetic flux controlling member 300 of Embodiment 3 was used. Note that for comparison, a case where no electromagnetic flux controlling member is provided, and cases where the following electromagnetic flux controlling members 2100 to 2500 of Comparative Examples 1 to 5 were used were also examined.

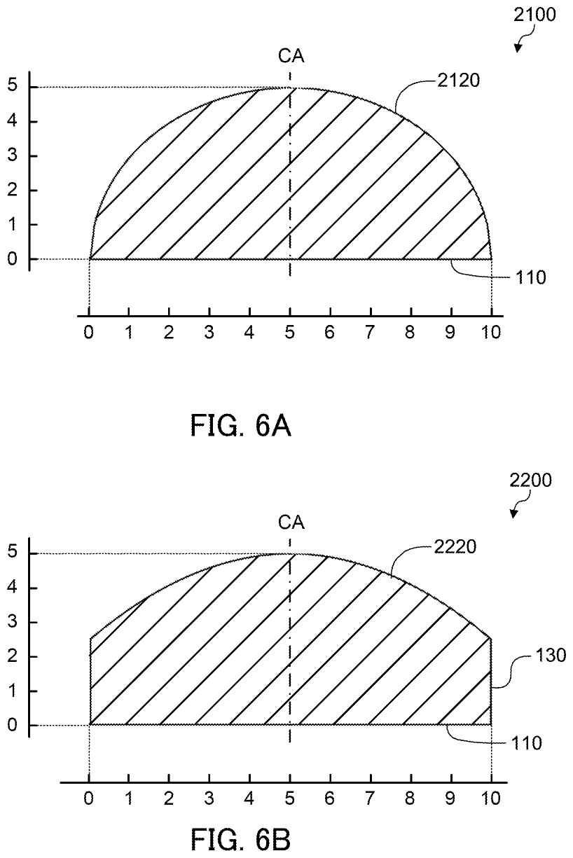

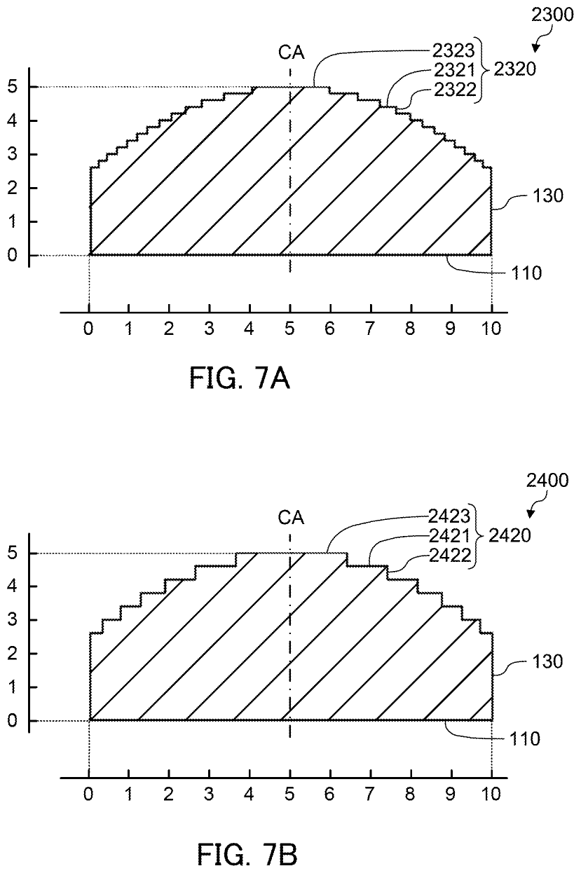

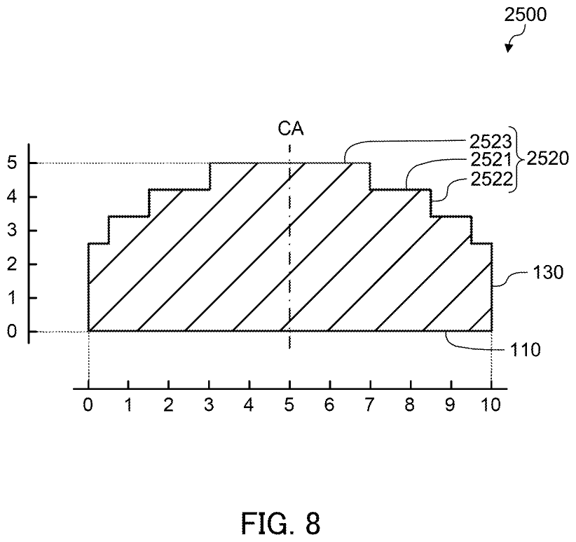

FIG. 6A is a sectional view illustrating a configuration of electromagnetic flux controlling member 2100 of Comparative Example 1, and FIG. 6B is a sectional view illustrating a configuration of electromagnetic flux controlling member 2200 of Comparative Example 2. FIG. 7A is a sectional view illustrating a configuration of electromagnetic flux controlling member 2300 of Comparative Example 3, and FIG. 7B is a sectional view illustrating a configuration of electromagnetic flux controlling member 2400 of Comparative Example 4. FIG. 8 is a sectional view illustrating a configuration of electromagnetic flux controlling member 2500 of Comparative Example 5.

As illustrated in FIG. 6A, electromagnetic flux controlling member 2100 of Comparative Example 1 includes first region 110 and second region 2120. First region 110 of electromagnetic flux controlling member 2100 of this Comparative Example is a flat surface, and second region 2120 is a spherical surface whose rotation axis is central axis CA. Electromagnetic flux controlling member 2100 of this Comparative Example is circularly symmetrical about central axis CA.

As illustrated in FIG. 6B, electromagnetic flux controlling member 2200 of Comparative Example 2 includes first region 110, second region 2220 and side surface 130. First region 110 of electromagnetic flux controlling member 2200 of this Comparative Example is a flat surface, and second region 2220 is a curved surface with a curvature smaller than that of a sphere. More specifically, in this Comparative Example, second region 220 is circularly symmetrical about central axis CA, and is configured such that the curvature decreases from the front side (center portion) toward the rear side (side surface side).

Electromagnetic flux controlling member 2300 of Comparative Example 3 differs from the configuration of electromagnetic flux controlling member 100 of Embodiment 1 in the shape of second region 2320. In view of this, the same components as those of electromagnetic flux controlling member 100 of Embodiment 1 are denoted with the same reference numerals, and the description thereof will be omitted. As illustrated in FIG. 7A, electromagnetic flux controlling member 2300 of Comparative Example 3 includes first region 110, second region 2320 and side surface 130. First region 110 of electromagnetic flux controlling member 2300 of this Comparative Example is a flat surface. Second region 2320 includes a plurality of circular parts 2321, a plurality of first step surfaces 2322, and top surface 2323. In this Comparative Example, the widths of the plurality of circular parts 2321 differ from each other. In this Comparative Example, the width of circular part 2321 gradually decreases from the center portion toward the outer periphery portion. In addition, the diameter of top surface 2323 is 2.0 mm. In this Comparative Example, the difference in height (the height of first step surface 2322) of the outer edges of two circular parts 2321 adjacent to each other is the same, and its difference is 0.2 mm.

Electromagnetic flux controlling member 2400 of Comparative Example 4 differs from the configuration of electromagnetic flux controlling member 100 of Embodiment 1 in the shape of second region 2420. In view of this, the same components as those of electromagnetic flux controlling member 100 of Embodiment 1 are denoted with the same reference numerals, and the description thereof will be omitted. As illustrated in FIG. 7B, electromagnetic flux controlling member 2400 of Comparative Example 4 includes first region 110, second region 2420 and side surface 130. First region 110 of electromagnetic flux controlling member 2400 of this Comparative Example is a flat surface. Second region 2420 includes a plurality of circular parts 2421, a plurality of first step surfaces 2422, and top surface 2423. In this Comparative Example, the widths of the plurality of circular parts 2421 differ from each other. In this Comparative Example, the width of circular part 2421 gradually decreases from the center portion toward the outer periphery portion. In addition, the diameter of top surface 2423 is 2.8 mm. In this Comparative Example, the difference in height (the height of first step surface 2422) of the outer edges of two circular parts 2421 adjacent to each other is the same, and its difference is 0.4 mm.

Electromagnetic flux controlling member 2500 of Comparative Example 5 differs from the configuration of electromagnetic flux controlling member 100 of Embodiment 1 in the shape of second region 2520. In view of this, the same components as those of electromagnetic flux controlling member 100 of Embodiment 1 are denoted with the same reference numerals, and the description thereof will be omitted. As illustrated in FIG. 8, electromagnetic flux controlling member 2500 of Comparative Example 5 includes first region 110, second region 2520 and side surface 130. First region 110 of electromagnetic flux controlling member 2500 of this Comparative Example is a flat surface. Second region 2520 includes a plurality of circular parts 2521, a plurality of first step surfaces 2522, and top surface 2523. In this Comparative Example, the widths of the plurality of circular parts 2521 differ from each other. In this Comparative Example, the width of circular part 2521 gradually decreases from the center portion toward the outer periphery portion. In addition, the diameter of top surface 2523 is 4.0 mm. In this Comparative Example, the difference in height (the height of first step surface 2522) of the outer edges of two circular parts 2521 adjacent to each other is the same, and its difference is 0.8 mm.

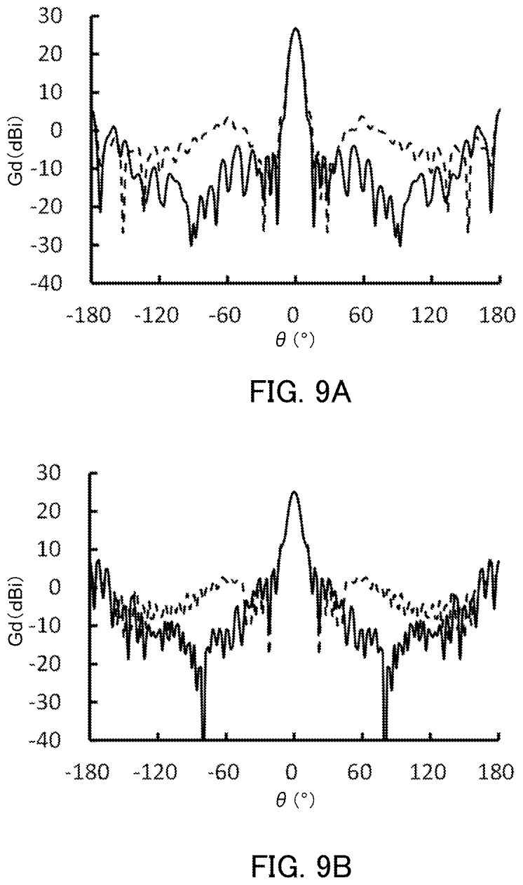

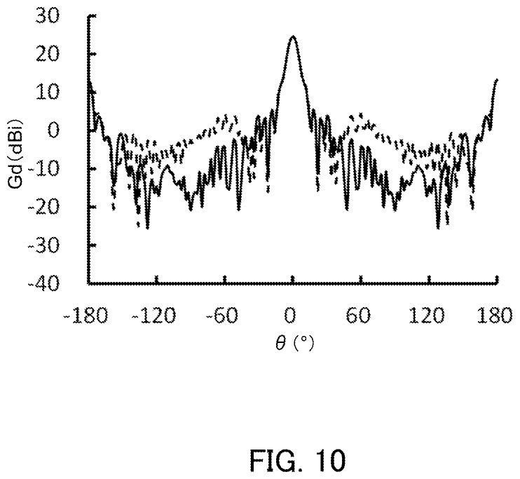

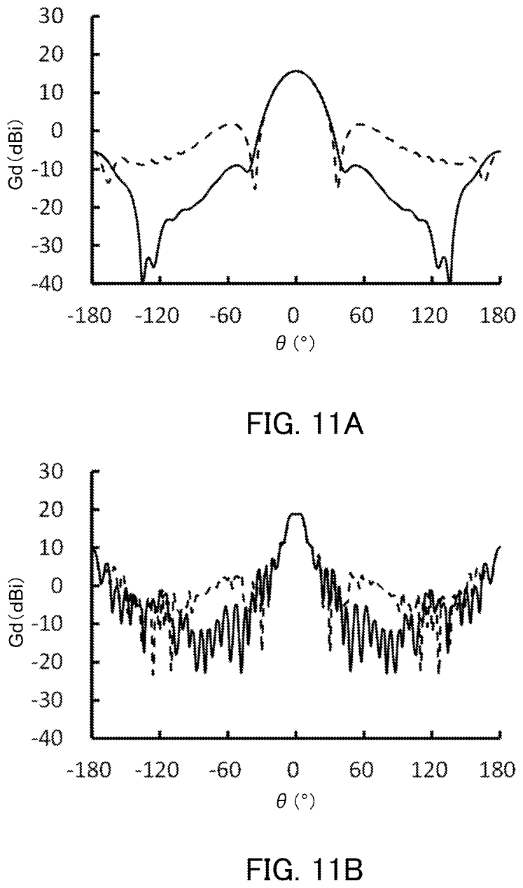

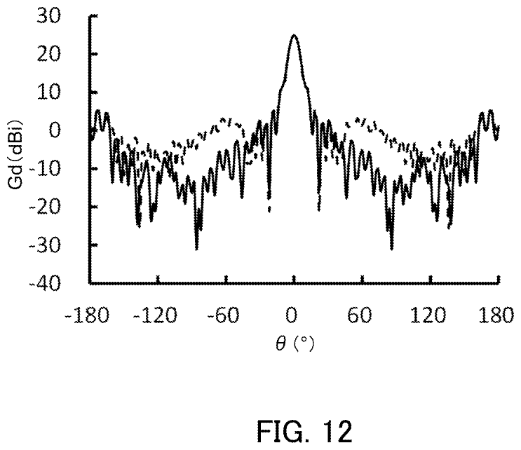

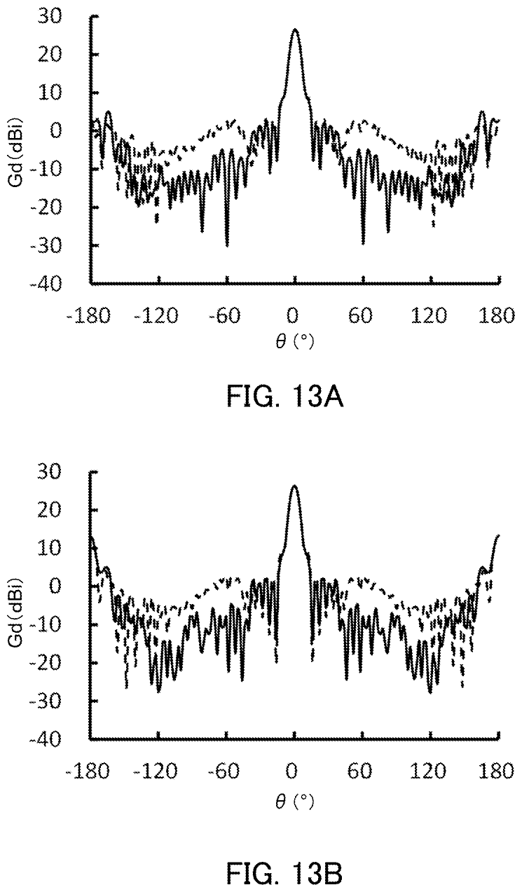

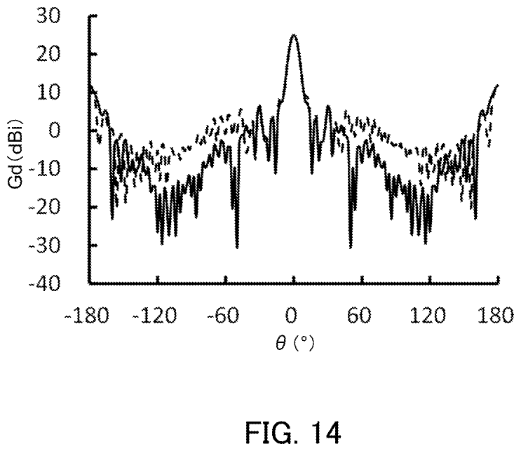

FIG. 9A is a graph showing a simulation result of a case where electromagnetic flux controlling member 100 of Embodiment 1 is used, and FIG. 9B is a graph showing a simulation result of a case where electromagnetic flux controlling member 200 of Embodiment 2 is used. FIG. 10 is a graph showing a simulation result of a case where electromagnetic flux controlling member 300 of Embodiment 3 is used. FIG. 11A is a graph showing a simulation result of a case where no electromagnetic flux controlling member is used, and FIG. 11B is a graph showing a simulation result of a case where electromagnetic flux controlling member 2100 of Comparative Example 1 is used. FIG. 12 is a graph showing a simulation result of a case where electromagnetic flux controlling member 2200 of Comparative Example 2 is used. FIG. 13A is a graph showing a simulation result of a case where electromagnetic flux controlling member 2300 of Comparative Example 3 is used, and FIG. 13B is a graph showing a simulation result of a case where electromagnetic flux controlling member 2400 of Comparative Example 4 is used. FIG. 14 is a graph showing a simulation result of a case where electromagnetic flux controlling member 2500 of Comparative Example 5 is used.

In FIGS. 9A to 14, the abscissa indicates the angle with respect to the reference line, and the ordinate indicates the antenna gain. In FIGS. 9A to 14, the solid line indicates results in the XZ plane, and the broken line indicates results in the YZ plane.

Table 1 shows the relationship between the type the electromagnetic flux controlling member used, the maximum gain, and the maximum gain power. Here, the maximum gain means the maximum value of the obtained antenna gain. In addition, the maximum gain power means the ratio of the maximum gain to the antenna gain in the case where the maximum gain measured with only the radio wave source is set as 1.

TABLE 1

| Type of Electromagnetic | Maximum | Maximum |
|---|---|---|
| Flux Controlling Member | Gain | Gain Power |
| Embodiment 1 | 26.80 | 473.7 |
| Embodiment 2 | 25.10 | 324.2 |
| Embodiment 3 | 24.58 | 287.5 |
| With Horn Antenna Alone | 15.68 | 37.19 |
| Comparative Example 1 | 18.71 | 74.47 |
| Comparative Example 2 | 24.91 | 310.1 |
| Comparative Example 3 | 26.50 | 447.5 |
| Comparative Example 4 | 26.42 | 439.1 |
| Comparative Example 5 | 25.03 | 318.7 |

FIG. 9A and Table 1 show that in the case where electromagnetic flux controlling member 100 of Embodiment 1 (the width of circular part 221 is approximately ⅕ with respect to the wavelength of the electromagnetic waves, and is 0.2 mm) is used, the radio waves gather in the direction (the Z direction) from the radio wave source toward electromagnetic flux controlling member 100. Note that in comparison with electromagnetic flux controlling member 500 of Comparative Example 2, the maximum gain power was significantly increased.

FIG. 9B and Table 1 show that in the case where electromagnetic flux controlling member 200 of Embodiment 2 (the width of circular part 221 is approximately ⅓ with respect to the wavelength of the electromagnetic waves, and is 0.4 mm) is used, the radio waves gather in the direction from the radio wave source toward electromagnetic flux controlling member 200. Note that approximately the same maximum gain value as that of electromagnetic flux controlling member 100 of Embodiment 1 was obtained. Note that in comparison with electromagnetic flux controlling member 2200 of Comparative Example 2, the maximum gain and the maximum gain power were slightly increased.

FIG. 10 and Table 1 show that in the case where electromagnetic flux controlling member 300 of Embodiment 3 (the width of circular part 221 is approximately ⅘ with respect to the wavelength of the electromagnetic waves, and is 0.8 mm) is used, the radio waves gather in the direction from the radio wave source toward electromagnetic flux controlling member 300. Note that in comparison with electromagnetic flux controlling member 100 of Embodiment 1, the maximum gain was slightly reduced; however, electromagnetic flux controlling member 300 of Embodiment 3 is advantageous in terms of productivity because the width of circular part 321 is large. Note that in comparison with electromagnetic flux controlling member 2200 of Comparative Example 2, the productivity was improved while the maximum gain and the maximum gain power were slightly reduced.

On the other hand, FIG. 11A and Table 1 show that in the case where no electromagnetic flux controlling member is used, electromagnetic waves do not gather in the Z direction.

FIG. 11B and Table 1 show that in the case where electromagnetic flux controlling member 2100 of Comparative Example 1 (second region 2120 is sphere) is used, the maximum gain was increased in comparison with the case where no electromagnetic flux controlling member is used although not as much as electromagnetic flux controlling members 100 to 300 of Embodiments 1 to 3.

FIG. 12 and Table 1 show that in the case where electromagnetic flux controlling member 2200 of Comparative Example 2 (the sphere of second region 2220 is gentler) is used, the maximum gain was further increased in comparison with electromagnetic flux controlling member 200 of Comparative Example 1, as in electromagnetic flux controlling members 100 to 300 of Embodiments 1 to 3.

FIG. 13A and Table 1 show that in the case where electromagnetic flux controlling member 2300 of Comparative Example 3 (the difference in height of the outer edges of two circular parts 2321 adjacent to each other is 0.2 mm) is used, the maximum gain was slightly reduced in comparison with electromagnetic flux controlling member 100 of Embodiment 1.

FIG. 13B and Table 1 show that in the case where electromagnetic flux controlling member 2400 of Comparative Example 4 (the difference in height of the outer edges of two circular parts 2421 adjacent to each other is 0.4 mm) is used, the maximum gain was slightly increased in comparison with electromagnetic flux controlling member 200 of Embodiment 2.

FIG. 14 and Table 1 show that in the case where electromagnetic flux controlling member 2500 of Comparative Example 5 (the difference in height of the outer edges of two circular parts 2521 adjacent to each other is 0.8 mm) is used, the maximum gain was slightly increased in comparison with electromagnetic flux controlling member 300 of Embodiment 3.

In the case with horn antenna 10 alone, no electromagnetic wave gathered because no electromagnetic flux controlling member was used. In the case where electromagnetic flux controlling members 2100 and 2200 of Comparative Examples 1 and 2 were used, sufficient maximum gain was not obtained because the circular part with constant width is not provided. In the case where electromagnetic flux controlling members 2300, 2400 and 2500 of Comparative Examples 3 to 5 were used, there is no significant change in comparison with the maximum gain of electromagnetic flux controlling members 100 to 300 of Embodiments 1 to 3, but the adjustment of the characteristics of second regions 2320, 2420 and 2520 using the forming mold is difficult because the widths of circular parts 2321, 2421 and 2521 are not constant.

### Embodiment 4

### Configuration of Electromagnetic Flux Controlling Member

Next, electromagnetic flux controlling member 400 according to Embodiment 4 is described. Electromagnetic flux controlling member 400 according to the present embodiment differs from electromagnetic flux controlling member 100 according to Embodiment 1 in the shape of first region 410. In view of this, the same components as those of electromagnetic flux controlling member 100 of Embodiment 1 are denoted with the same reference numerals, and the description thereof will be omitted.

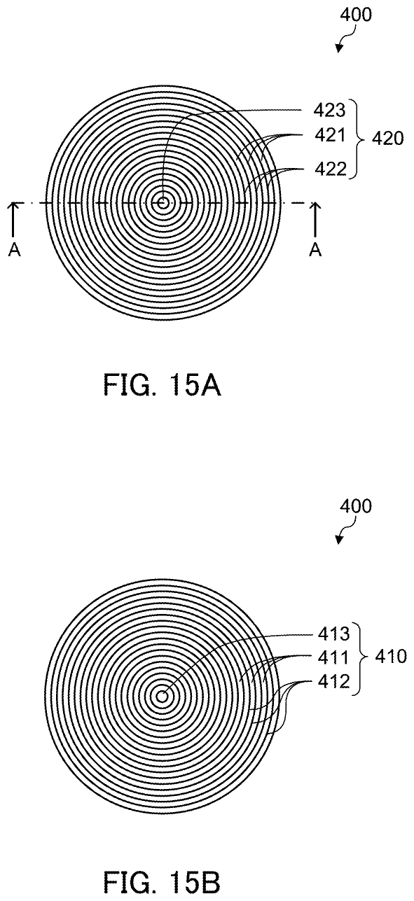

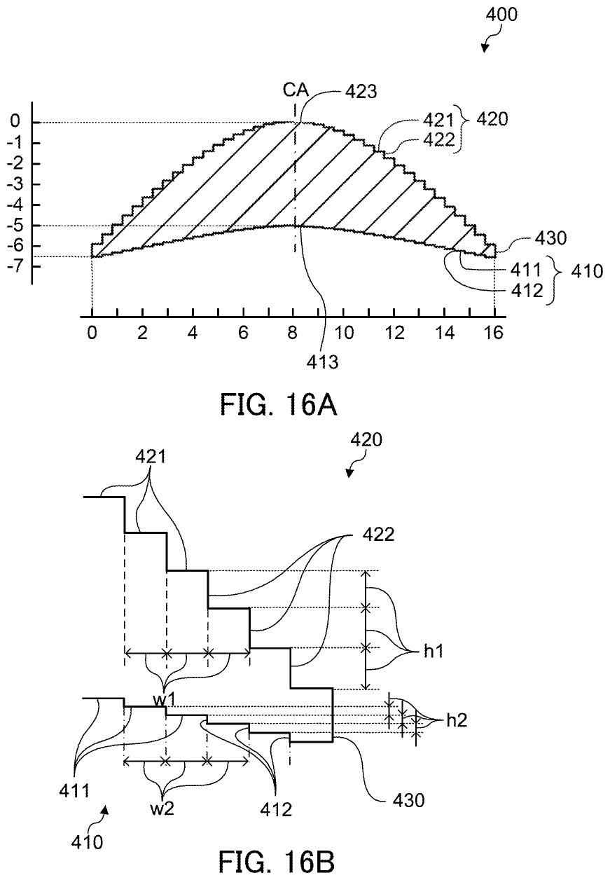

FIG. 15A is a plan view of electromagnetic flux controlling member 400 according to Embodiment 2, and FIG. 15B is a bottom view. FIG. 16A is a sectional view taken along line A-A of FIG. 15A, and FIG. 16B is a partially enlarged sectional view of FIG. 16A.

As illustrated in FIGS. 15A, 15B, 16A and 16B, electromagnetic flux controlling member 400 includes first region 410 and second region 420. In the present embodiment, electromagnetic flux controlling member 400 further includes side surface 430.

First region 410 is a region for allowing electromagnetic waves to enter electromagnetic flux controlling member 400. First region 410 is disposed to intersect central axis CA of electromagnetic flux controlling member 400. Note that in the present embodiment, electromagnetic flux controlling member 400 has a height of 6.5 mm, and a diameter in plan view of 16 mm.

The shape of first region 410 is not limited as long as the above-mentioned function can be ensured. In the present embodiment, the shape of first region 410 is the inner surface of a concave part. In the present embodiment, the shape of first region 410 is rotationally symmetrical (circularly symmetrical) about central axis CA as the rotation axis. In the present embodiment, first region 410 includes a plurality of circular parts 411 on second region 420 side, a plurality of second step surfaces 412, and bottom surface 413.

The plurality of circular parts 411 on second region 420 side is optical surfaces with a circular shape concentrically disposed in plan view. Circular part 411 allows electromagnetic waves to enter electromagnetic flux controlling member 400. Circular part 411 may be a flat surface perpendicular to central axis CA or a tilted surface. In the present embodiment, circular part 411 is a flat surface perpendicular to central axis CA.

The outer edges of the plurality of circular parts 411 are disposed to come closer to the front side with increasing distance to central axis CA. Specifically, in the present embodiment, the plurality of circular parts 411 is disposed stepwise such that the height of the outer edge of the concave part gradually decreases with increasing distance to central axis CA. Widths w2 of at least some of circular parts 411 of the plurality of circular parts 411 are the same, and are smaller than the wavelength of the electromagnetic waves used. In the present embodiment, widths w2 of the plurality of circular parts 411 are constant, and are smaller than the wavelength of the electromagnetic waves used. In addition, the diameter of the bottom surface is 0.8 mm. Width w2 of circular part 411 is appropriately selected in accordance with the wavelength of the electromagnetic waves used. When width w2 of circular part 411 is equal to or greater than the wavelength of the electromagnetic waves used, the maximum gain may possibly be reduced.

Preferably, width w2 (pitch) of circular parts 411 adjacent to each other is within a range of 0.2 to 1.0 mm. If width w2 of the plurality of circular parts 411 is smaller than 0.2 mm, the fabrication of forming mold 150 becomes difficult. On the other hand, if width w2 of circular part 411 is greater than 1.0 mm, the maximum gain may possibly be reduced. In the present embodiment, width w2 (pitch) of the plurality of circular parts 411 is 0.4 mm.

Second step surface 412 is a curved surface disposed to surround central axis CA, and connects two circular parts 411 adjacent to each other. Circular part 411 is connected to each of the upper end and lower end of second step surface 412. The shape of second step surface 412 is not limited as long as the above-mentioned function can be ensured. The shape of second step surface 412 may be a shape of the side surface of a column, a shape of the side surface of a truncated cone, a shape of the side surface of an inverted truncated cone, or a shape of the side surface of a cylinder. Preferably, the shape of second step surface 412 is a shape of the side surface of a column. Specifically, second step surface 412 may be parallel to central axis CA, or tilted to central axis CA. In the present embodiment, second step surface 412 is parallel to central axis CA. Here, in the present embodiment, as described above, circular part 411 is a curved surface perpendicular to central axis CA, and second step surface 412 has a shape of the side surface of a cylinder. Specifically, in the present embodiment, circular part 411 and second step surface 412 are perpendicularly connected. In the direction along central axis CA, heights h2 of second step surfaces 412 are set such that most of them increase as it goes from the front side (center portion) toward the rear side (side surface side) of electromagnetic flux controlling member 400. Note that outermost height h2 of second step surface 412 may be smaller than height h2 of second step surface 412 at the center.

Second region 420 is a region for emitting, to the outside of electromagnetic flux controlling member 400, the electromagnetic waves entered from first region 410, while controlling the travelling direction. Second region 420 is disposed to intersect central axis CA of electromagnetic flux controlling member 400 with a convex shape in its entirety. In the present embodiment, second region 420 further includes a plurality of circular parts 421, a plurality of first step surfaces 422, and top surface 423.

The plurality of circular parts 421 is optical surfaces with a circular shape concentrically disposed in plan view. Circular part 421 emits, to the outside, a part of the electromagnetic waves entered from first region 410. Circular part 421 may be a flat surface perpendicular to central axis CA or a tilted surface. In the present embodiment, circular part 421 is a flat surface perpendicular to central axis CA.

The outer edges of the plurality of circular parts 421 are disposed to come closer to the rear side with increasing distance from central axis CA. Specifically, in the present embodiment, the plurality of circular parts 421 is disposed stepwise such that the height of first region 410 gradually decreases with increasing distance from central axis CA. Widths w1 of at least some of the plurality of circular parts 421 are the same, and are smaller than the wavelength of the electromagnetic waves used. Note that in the present embodiment, widths w1 of all circular parts 421 are the same, and are smaller than the wavelength of the electromagnetic waves used. Width w1 of circular part 421 is appropriately selected in accordance with the wavelength of the electromagnetic waves used. If width w1 of circular part 421 is equal to or greater than the wavelength of the electromagnetic waves used, the maximum gain may possibly be reduced.

Preferably, each width w1 (pitch) of circular parts 421 adjacent to each other is within a range of 0.2 to 1.0 mm. If width w1 of the plurality of circular parts 421 is smaller than 0.2 mm, it may be difficult to fabricate forming mold 150. On the other hand, if width w1 of circular part 421 is greater than 1.0 mm, the maximum gain may possibly be reduced. In the present embodiment, width w1 (pitch) of the plurality of circular parts 421 is 0.4 mm. In addition, the diameter of top surface 423 is 0.8 mm.

First step surface 422 is a curved surface disposed to surround central axis CA, and connects two circular parts 421 adjacent to each other. Circular part 421 is connected to the upper end and lower end of first step surface 422. In the present embodiment, first step surface 422 has a shape of the side surface of a column, and is parallel to central axis CA. Height h1 of first step surface 422 is set to increase in the direction from the front side (center portion) toward the rear side (side surface side) of electromagnetic flux controlling member 400.

The plurality of circular parts 411 and the plurality of circular parts 421 may or may not coincide with each other in plan view of electromagnetic flux controlling member 400 (in the direction along central axis CA). In the present embodiment, the plurality of circular parts 411 and the plurality of circular parts 421 respectively coincide with each other in plan view of electromagnetic flux controlling member 400.

Side surface 430 is a curved surface disposed to surround central axis CA and connects the outer edge of first region 410 and the outer edge of second region 420. The shape of side surface 430 is not limited. In the present embodiment, the shape of side surface 430 is a shape of the side surface of a column. Note that electromagnetic flux controlling member 400 may not include side surface 430. In this case, first region 410 and second region 420 are directly connected to each other.

### Forming Mold

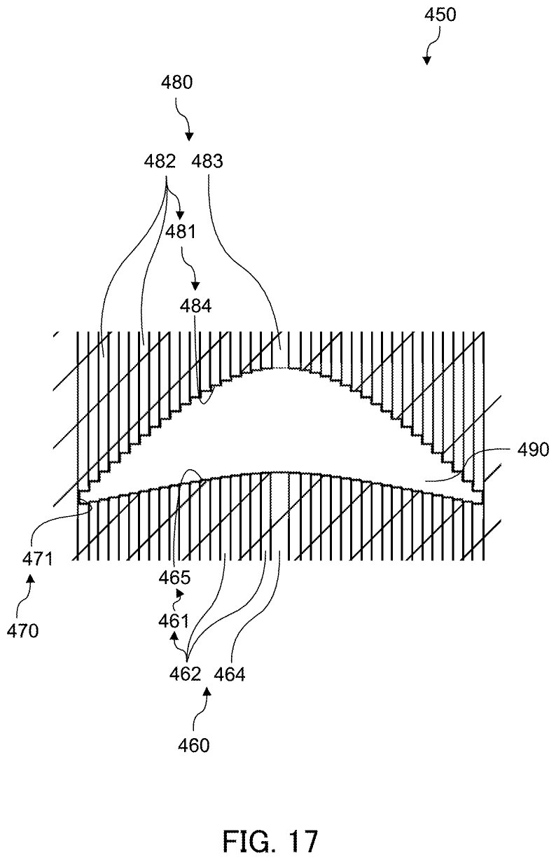

FIG. 17 is a sectional view of forming mold 450. Forming mold 450 is for forming the above-mentioned electromagnetic flux controlling member 400, and forms cavity 490 with a shape complementary to electromagnetic flux controlling member 400.

The material of forming mold 450 is not limited as long as a rigidity with which electromagnetic flux controlling member 400 can be formed with the forming material provided thereto, and may be appropriately selected from publicly known materials. Examples of the material of forming mold 450 include metal.

The number of the pieces of forming mold 450 is not limited. In the present embodiment, forming mold 450 includes first forming mold 460, second forming mold 470, and third forming mold 480.

First forming mold 460 is a piece for forming first region 410. First forming mold 460 includes first transfer surface 461 with a shape complementary to first region 410 of electromagnetic flux controlling member 400. First transfer surface 461 includes the surface corresponding to the plurality of circular parts 411, and the surface corresponding to the plurality of second step surfaces 412, and the surface corresponding to bottom surface 413. In addition, first forming mold 460 includes a plurality of first forming pieces 462 (the forming piece in claims) for forming circular part 411 and second step surface 412, and fifth forming piece 464 for forming top surface 423.

The plurality of first forming pieces 462 is concentric cylindrical pieces. First forming piece 462 may include first transfer surface 465 with a circular shape in plan view for forming some of the plurality of circular parts 411, and a transfer surface with a circular shape in plan view for forming one of the plurality of circular parts 411. In the present embodiment, each of the plurality of first forming pieces 462 includes first transfer surface 465 with a circular shape in plan view for forming one of the plurality of circular parts 411. Therefore, in the present embodiment, the number of first forming pieces 462 is the same as the number of circular parts 411 to be formed. The width of first transfer surface 465 of first forming piece 462 is the same as the width of circular part 411. Specifically, in the present embodiment, first transfer surface 465 has a width of 0.4 mm. One surface corresponding to second step surface 412 is provided in the case where first forming piece 462 is provided with one first transfer surface 465, whereas a plurality of surfaces corresponding to the plurality of second step surfaces 412 is provided in the case where first forming piece 462 is provided with a plurality of first transfer surfaces 465.

In the present embodiment, the plurality of first forming pieces 462 is disposed such that respective transfer surfaces come closer to first transfer surface 465 side as it goes from the center portion toward the outer periphery portion. The shape of first region 410 can be easily designed and modified by changing the shape of first transfer surface 465 by changing the positions of the plurality of first forming pieces 462.

Second forming mold 470 is a piece for forming side surface 430 of electromagnetic flux controlling member 400. Second forming mold 470 includes second transfer surface 471 with a shape complementary to side surface 430 of electromagnetic flux controlling member 400. In the present embodiment, side surface 430 has a shape of the side surface of a column, and therefore the shape of second transfer surface 471 is a shape of the side surface of a cylinder. The number of the pieces of second forming mold 470 may be one, or more. In the present embodiment, one second forming mold 470 is provided.

Third forming mold 480 is a piece for forming second region 420. Third forming mold 480 includes third transfer surface 481 with a shape complementary to second region 420 of electromagnetic flux controlling member 400. Third transfer surface 481 includes the surface corresponding to the plurality of circular parts 421, the surface corresponding to the plurality of first step surfaces 422, and the surface corresponding to top surface 423. In addition, third forming mold 480 includes a plurality of third forming pieces 482 (the forming piece in claims) for forming circular part 421 and first step surface 422, and fourth forming piece 483 for forming top surface 423.

The plurality of third forming pieces 482 is concentric cylindrical pieces. Third forming piece 482 may include transfer surface 484 with a circular shape in plan view for forming some of the plurality of circular parts 421, and may each include a transfer surface with a circular shape in plan view for forming one of the plurality of circular parts 421. In the present embodiment, each of the plurality of third forming pieces 482 includes transfer surface 484 with a circular shape in plan view for forming one of the plurality of circular parts 421. Therefore, in the present embodiment, the number of third forming pieces 482 is the same as the number of shape circular parts 421. The width of transfer surface 484 of third forming piece 482 is the same as the width of circular part 421. Specifically, in the present embodiment, transfer surface 484 has a width of 0.4 mm. One surface corresponding to first step surface 422 is provided in the case where third forming piece 482 is provided with one transfer surface 484, whereas a plurality of surfaces corresponding the plurality of first step surfaces 422 is provided in the case where third forming piece 482 is provided with a plurality of transfer surfaces 484.

In the present embodiment, the plurality of third forming pieces 482 is disposed such that respective transfer surfaces come closer to first transfer surface 461 side as it goes from the center portion toward the outer periphery portion. The shape of second region 420 can be easily designed and modified by changing the shape of third transfer surface 481 by changing the positions of the plurality of third forming pieces 482.

Fourth forming piece 483 is a columnar piece disposed inside innermost third forming piece 482. The top surface of the column is the surface corresponding to top surface 423. The size of the top surface of the column corresponds to the size of top surface 423. In the present embodiment, the diameter of the top surface of the column is 0.8 mm.

Electromagnetic flux controlling member 400 can be produced through injection molding using forming mold 450 having the above-mentioned configuration.

### Embodiment 5

Next, electromagnetic flux controlling member 500 of Embodiment 5 is described. Electromagnetic flux controlling member 500 of Embodiment 5 is different from electromagnetic flux controlling member 400 of Embodiment 4 in the shape of first region 510. In view of this, the same components as those of electromagnetic flux controlling member 400 of Embodiment 4 are denoted with the same reference numerals, and the description thereof will be omitted.

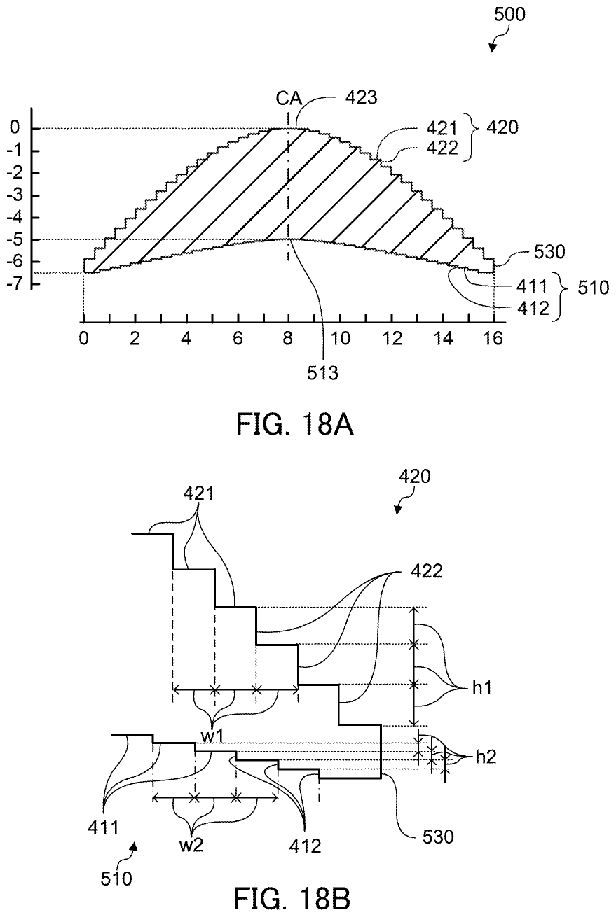

FIG. 18A is a sectional view of electromagnetic flux controlling member 500 of Embodiment 5, and FIG. 18B is a sectional view illustrating a relationship between first region 510 and second region 420.

As illustrated in FIGS. 18A and 18B, electromagnetic flux controlling member 500 of Embodiment 5 includes first region 510 and second region 420. Note that in the present embodiment, electromagnetic flux controlling member 500 further includes side surface 530.

In the present embodiment, first region 510 includes the plurality of circular parts 411, the plurality of second step surfaces 412, and bottom surface 513.

The outer edges of the plurality of circular parts 411 are disposed to come closer to the front side with increasing distance to central axis CA. Specifically, in the present embodiment, the plurality of circular parts 411 is disposed stepwise such that the height of the outer edge of the concave part gradually decreases with increasing distance to central axis CA. In the cross section including central axis CA, widths w2 of the plurality of circular parts 411 are constant, and are smaller than the wavelength of the electromagnetic waves used.

In the present embodiment, distance w2 (pitch) between the outer edges of circular parts 411 adjacent to each other is 0.4 mm, and width w2 of the outermost circular part 411 is mm. In addition, the diameter of bottom surface 513 is 0.4 mm.

Second region 420 is the same as second region 420 of Embodiment 4. Specifically, second region 420 of the present embodiment includes the plurality of circular parts 421, the plurality of first step surfaces 422, and top surface 423. The plurality of circular parts 421 is concentric circular optical surfaces. The outer edges of the plurality of circular parts 421 are disposed to come closer to the rear side with increasing distance from central axis CA. Specifically, in the present embodiment, the plurality of circular parts 421 is disposed stepwise such that the height of first region 410 gradually decreases with increasing distance from central axis CA. Widths w1 of at least some of the plurality of circular parts 421 are the same, and are smaller than the wavelength of the electromagnetic waves used. Note that in the present embodiment, widths w1 of all circular parts 421 are the same.

In the present embodiment, the distance (pitch) between the outer edges of circular parts 421 adjacent to each other is 0.4 mm. In the present embodiment, 18 circular parts 421 are provided. In addition, the diameter of the top surface is 0.8 mm. Note that electromagnetic flux controlling member 500 may not include side surface 530. In this case, first region 510 and second region 420 may be directly connected to each other.

In the present embodiment, the region (bottom surface 513) other than circular part 421 intersecting central axis CA is smaller than the region (top surface 423) other than circular part 411 intersecting central axis CA. In plan view of electromagnetic flux controlling member 500, the plurality of circular parts 411 and the plurality of circular parts 421 do not coincide with each other. More specifically, in the present embodiment, the positions of the plurality of circular parts 411 are respectively shifted to central axis CA side from the plurality of circular parts 421 by a half pitch.

### Embodiment 6

Next, electromagnetic flux controlling member 600 of Embodiment 6 is described. Electromagnetic flux controlling member 600 of Embodiment 6 is different from electromagnetic flux controlling member 400 of Embodiment 4 in the shape of second region 620. In view of this, the same components as those of electromagnetic flux controlling member 400 of Embodiment 4 are denoted with the same reference numerals, and the description thereof will be omitted.

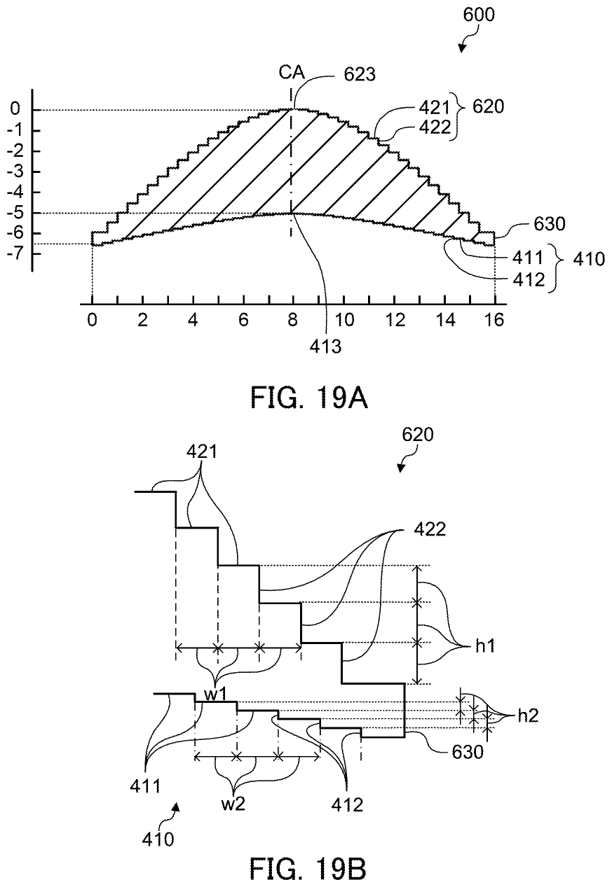

FIG. 19A is a sectional view of electromagnetic flux controlling member 600 of Embodiment 6, and FIG. 19B is a sectional view illustrating a relationship between first region 410 and second region 620.

As illustrated in FIGS. 19A and 19B, electromagnetic flux controlling member 600 of Embodiment 6 includes first region 410 and second region 620. Note that in the present embodiment, electromagnetic flux controlling member 600 further includes side surface 630.

In the present embodiment, first region 410 includes the plurality of circular parts 411, the plurality of second step surfaces 412, and bottom surface 413.

The outer edges of the plurality of circular parts 411 is disposed to come closer to the rear side with increasing distance to central axis CA. Specifically, in the present embodiment, the plurality of circular parts 411 is disposed stepwise such that the height of the outer edge of the concave part gradually decreases with increasing distance to central axis CA. Widths w1 of at least some of the plurality of circular parts 411 are the same, and are smaller than the wavelength of the electromagnetic waves used. Note that in the present embodiment, widths w1 of all circular parts 421 are the same.

In the present embodiment, distance w2 (pitch) between the outer edges of circular parts 411 adjacent to each other is 0.4 mm. In addition, the diameter of bottom surface 413 is mm.

Second region 620 of the present embodiment includes the plurality of circular parts 421, the plurality of first step surfaces 422, and top surface 623. The plurality of circular parts 421 is concentric circular optical surfaces. The outer edges of the plurality of circular parts 421 are disposed to come closer to the rear side with increasing distance from central axis CA. Specifically, in the present embodiment, the plurality of circular parts 421 is disposed stepwise such that the height of the outer edge of the concave part gradually decreases with increasing distance from central axis CA. Widths w1 of at least some of the plurality of circular parts 421 are the same and are smaller than the wavelength of the electromagnetic waves used. In the present embodiment, the distance (pitch) between the outer edges of circular parts 421 adjacent to each other is 0.4 mm, and width w1 of the outermost circular part 321 is 0.6 mm. In addition, the diameter of top surface 623 in plan view is 0.4 mm. Note that electromagnetic flux controlling member 600 may not include side surface 630. In this case, first region 410 and second region 620 may be directly connected to each other.

In the present embodiment, the inside (top surface 623) of innermost circular part 421 in second region 620 is smaller than the inside (bottom surface 413) of innermost circular part 411 in first region 410. In plan view of electromagnetic flux controlling member 600, the plurality of circular parts 411 and the plurality of circular parts 421 are not coincide with each other. More specifically, in the present embodiment, the positions of the plurality of circular parts 411 are respectively shifted from the plurality of circular parts 421 by a half pitch to the side away from central axis CA.

### Embodiment 7

Next, electromagnetic flux controlling member 700 of Embodiment 7 is described. Electromagnetic flux controlling member 700 of Embodiment 7 is different from electromagnetic flux controlling member 400 of Embodiment 4 in the shape of first region 710 and the shape of second region 720. In view of this, the same components as those of electromagnetic flux controlling member 400 of Embodiment 4 are denoted with the same reference numerals, and the description thereof will be omitted.

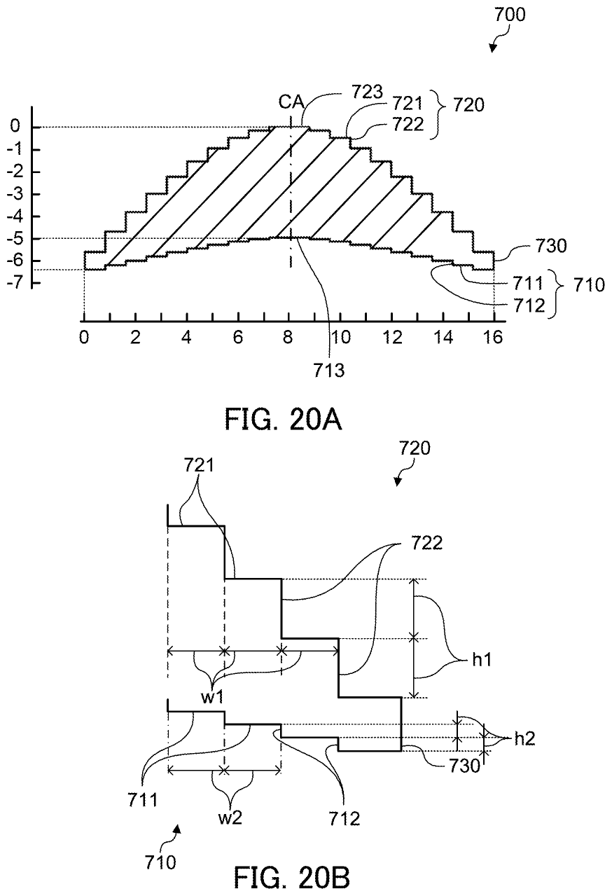

FIG. 20A is a sectional view of electromagnetic flux controlling member 700 of Embodiment 7, and FIG. 20B is a sectional view illustrating a relationship between first region 710 and second region 720.

As illustrated in FIGS. 20A and 20B, electromagnetic flux controlling member 700 of Embodiment 7 includes first region 710 and second region 720. Note that in the present embodiment, electromagnetic flux controlling member 700 further includes side surface 730.

In the present embodiment, first region 710 includes a plurality of circular parts 711, a plurality of second step surfaces 712, and bottom surface 713.

The outer edges of the plurality of circular parts 711 are disposed to come closer to the front side with increasing distance to central axis CA. Specifically, in the present embodiment, the plurality of circular parts 711 is disposed stepwise such that the height of the outer edge of the concave part gradually decreases with increasing distance to central axis CA. Widths w2 of at least some of circular parts 711 are the same, and are smaller than the wavelength of the electromagnetic waves used. Note that in the present embodiment, widths w2 of all circular parts 711 are the same, and are smaller than the wavelength of the electromagnetic waves used. Note that electromagnetic flux controlling member 700 may not include side surface 730. In this case, first region 710 and second region 720 may be directly connected to each other.

In the present embodiment, distance w2 (pitch) between the outer edges of circular parts 711 adjacent to each other is 0.8 mm. In addition, the diameter of bottom surface 713 is 1.6 mm.

Second region 720 of the present embodiment includes a plurality of circular parts 721, a plurality of first step surfaces 722, and top surface 723. The plurality of circular parts 721 is optical surfaces with a circular shape concentrically disposed in plan view. The outer edges of the plurality of circular parts 721 are disposed to come closer to the rear side with increasing distance from central axis CA. Specifically, in the present embodiment, the plurality of circular parts 721 is disposed stepwise such that the height of first region 710 gradually decreases with increasing distance from central axis CA. Widths w2 of at least some of circular parts 721 are the same, and are smaller than the wavelength of the electromagnetic waves used. Note that in the present embodiment, widths w2 of all circular parts 721 are the same, and are smaller than the wavelength of the electromagnetic waves used, and, smaller than the wavelength of the electromagnetic waves used.

In the present embodiment, the distance (pitch) between the outer edges of circular parts 721 adjacent to each other is 0.8 mm. In addition, the diameter of the bottom is 1.6 mm.

In the present embodiment, in plan view of electromagnetic flux controlling member 700, the plurality of circular parts 711 and the plurality of circular parts 721 are coincide with each other.

### Embodiment 8

Next, electromagnetic flux controlling member 800 of Embodiment 8 is described. Electromagnetic flux controlling member 800 of Embodiment 8 is different from electromagnetic flux controlling member 400 of Embodiment 4 in the shape of first region 810 and the shape of second region 720. In view of this, the same components as those of electromagnetic flux controlling member 400 of Embodiment 4 are denoted with the same reference numerals, and the description thereof will be omitted.

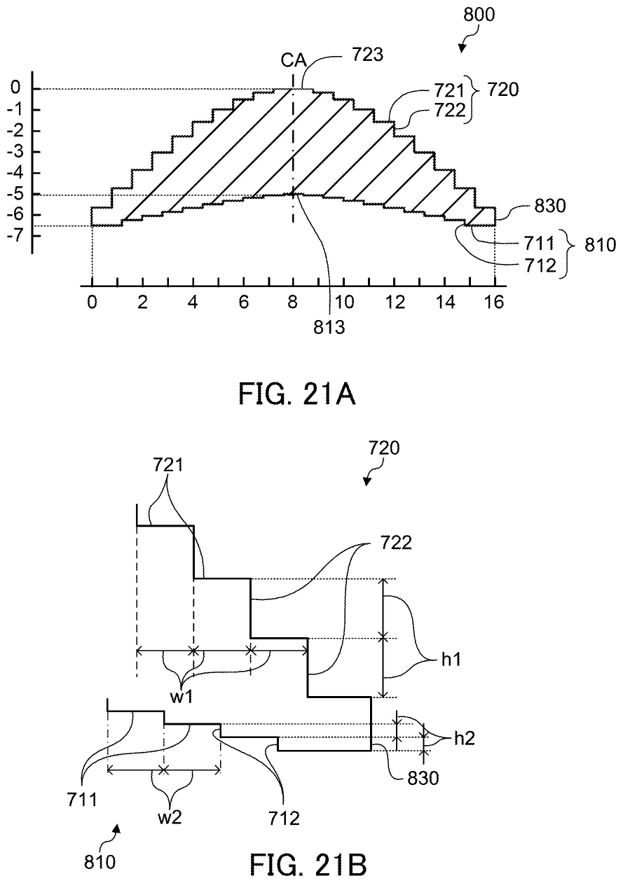

FIG. 21A is a sectional view of electromagnetic flux controlling member 800 of Embodiment 8, and FIG. 21B is a sectional view illustrating a relationship between first region 810 and second region 720.

As illustrated in FIGS. 21A and 21B, electromagnetic flux controlling member 800 of Embodiment 8 includes first region 810 and second region 720. Note that in the present embodiment, electromagnetic flux controlling member 800 further includes side surface 830.

In the present embodiment, first region 810 includes the plurality of circular parts 711, the plurality of second step surfaces 712, and bottom surface 813.

The outer edges of the plurality of circular parts 711 are disposed to come closer to the front side with increasing distance to central axis CA. Specifically, in the present embodiment, the plurality of circular parts 711 is disposed stepwise such that the height of the outer edge of the concave part gradually decreases with increasing distance to central axis CA. In the cross section including central axis CA, widths w2 of at least some of circular parts 711 are the same, and are smaller than the wavelength of the electromagnetic waves used. Note that electromagnetic flux controlling member 800 may not include side surface 830. In this case, first region 810 and second region 720 may be directly connected to each other.

In the present embodiment, the distance (pitch) between the outer edges of circular parts 711 adjacent to each other is 0.8 mm, and width w1 of the outermost circular part 711 is 1.2 mm. In addition, the diameter of bottom surface 813 is 0.8 mm.

Second region 720 of the present embodiment includes the plurality of circular parts 721, the plurality of first step surfaces 722, and top surface 723. The plurality of circular parts 721 is optical surfaces with a circular shape concentrically disposed in plan view. The outer edges of the plurality of circular parts 721 are disposed to come closer to the rear side with increasing distance from central axis CA. Specifically, in the present embodiment, the plurality of circular parts 721 is disposed stepwise such that the height of first region 810 gradually decreases with increasing distance from central axis CA. In the cross section including central axis CA, widths w1 of at least some of circular parts 721 are the same, and are smaller than the wavelength of the electromagnetic waves used. Note that in the present embodiment, widths w1 of all circular parts 721 are the same, and are smaller than the wavelength of the electromagnetic waves used.

In the present embodiment, the distance (pitch) between the outer edges of circular parts 721 adjacent to each other is 0.8 mm. In addition, the diameter of top surface 723 is 1.6 mm.

In the present embodiment, the inside (top surface 723) of innermost circular part 721 in second region 720 is larger than the inside (bottom surface 813) of innermost circular part 711 in first region 810. In plan view of electromagnetic flux controlling member 800, the plurality of circular parts 711 and the plurality of circular parts 721 do not coincide with each other. More specifically, in the present embodiment, the positions of the plurality of circular parts 711 are respectively shifted to central axis CA side by a half pitch from the plurality of circular parts 721.

### Embodiment 9

Next, electromagnetic flux controlling member 900 of Embodiment 9 is described. Electromagnetic flux controlling member 900 of Embodiment 9 is different from electromagnetic flux controlling member 400 of Embodiment 4 in the shape of second region 920. In view of this, the same components as those of electromagnetic flux controlling member 400 of Embodiment 4 are denoted with the same reference numerals, and the description thereof will be omitted.

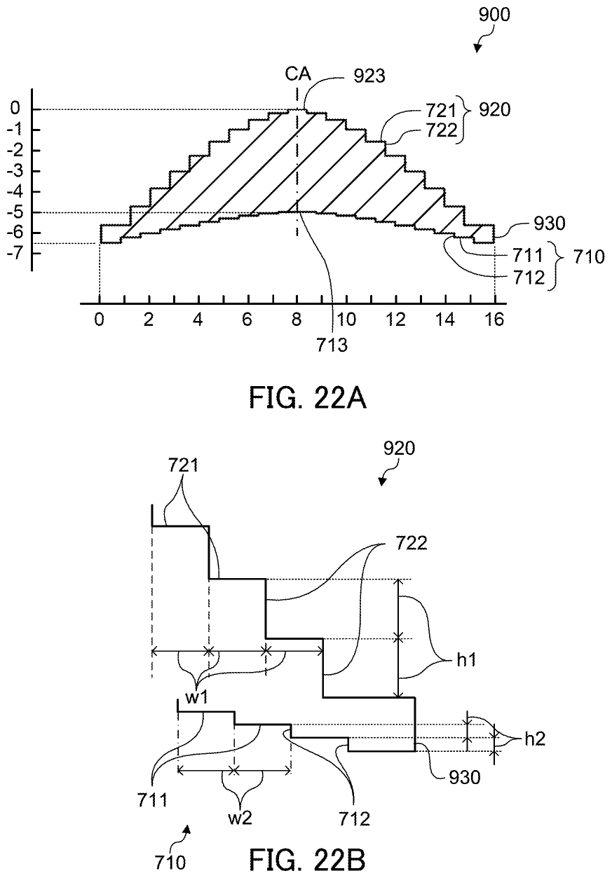

FIG. 22A is a sectional view of electromagnetic flux controlling member 900 of Embodiment 9, and FIG. 22B is a sectional view illustrating a relationship between first region 710 and second region 920.

As illustrated in FIGS. 22A and 22B, electromagnetic flux controlling member 900 of Embodiment 9 includes first region 710 and second region 920.

In the present embodiment, first region 710 includes the plurality of circular parts 711, the plurality of second step surfaces 712, and bottom surface 713.

The outer edges of the plurality of circular parts 711 are disposed to come closer to the front side with increasing distance to central axis CA. Specifically, in the present embodiment, the plurality of circular parts 711 is disposed stepwise such that the height of the outer edge of the concave part gradually decreases with increasing distance to central axis CA. Widths w2 of at least some of circular parts 711 are the same, and are smaller than the wavelength of the electromagnetic waves used. Note that electromagnetic flux controlling member 900 may not include side surface 930. In this case, first region 710 and second region 920 may be directly connected to each other.

In the present embodiment, distance w2 (pitch) between the outer edges of circular parts 711 adjacent to each other is 0.8 mm. In addition, the diameter of the top surface is 1.6 mm.

Second region 920 of the present embodiment includes the plurality of circular parts 721, the plurality of first step surfaces 722, and top surface 923. The plurality of circular parts 721 is optical surfaces with a circular shape concentrically disposed in plan view. The outer edges of the plurality of circular parts 721 are disposed to come closer to the rear side with increasing distance from central axis CA. Specifically, in the present embodiment, the plurality of circular parts 721 is disposed stepwise such that the height of first region 710 gradually decreases with increasing distance from central axis CA. Widths w1 of at least some of circular parts 721 are the same, and are smaller than the wavelength of the electromagnetic waves used.

In the present embodiment, the distance (pitch) between the outer edges of circular parts 721 adjacent to each other is 0.8 mm, and width w1 of the outermost circular part 721 is 1.2 mm. In addition, the diameter of the bottom is 1.6 mm.

In the present embodiment, the inside (top surface 923) of innermost circular part 721 in second region 920 is smaller than the inside (bottom surface 713) of innermost circular part 711 in first region 710. In plan view of electromagnetic flux controlling member 900, the plurality of circular parts 711 and the plurality of circular parts 721 do not coincide with each other. More specifically, in the present embodiment, the positions of the plurality of circular parts 711 are respectively shifted away from the central axis CA by a half pitch with respect to the plurality of circular parts 721.

### Simulations

Next, by using electromagnetic flux controlling members 400 to 900 of Embodiments 4 to 9, the relationship between the angle with respect to the reference line, and the maximum gain and the maximum gain power was examined.

The condition of the simulation is the same as that of the case of electromagnetic flux controlling members 100 to 300 of Embodiments 1 to 3, and therefore the description thereof will be omitted. Note that electromagnetic flux controlling members 400 to 900 used have a height of 6.5 mm, and a diameter in plan view of 16 mm. As the electromagnetic flux controlling member, electromagnetic flux controlling member 400 of Embodiment 4, electromagnetic flux controlling member 500 of Embodiment 5, electromagnetic flux controlling member 600 of Embodiment 6, electromagnetic flux controlling member 700 of Embodiment 7, electromagnetic flux controlling member 800 of Embodiment 8, and electromagnetic flux controlling member 900 of Embodiment 9 were used.

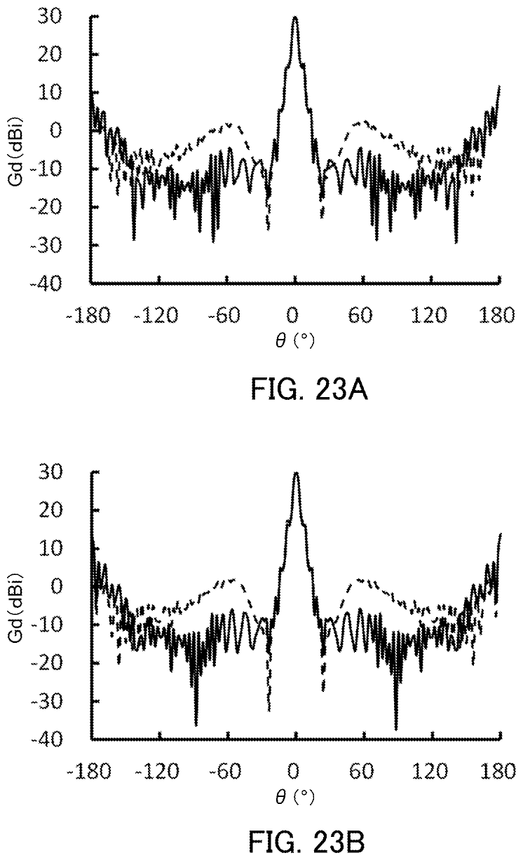

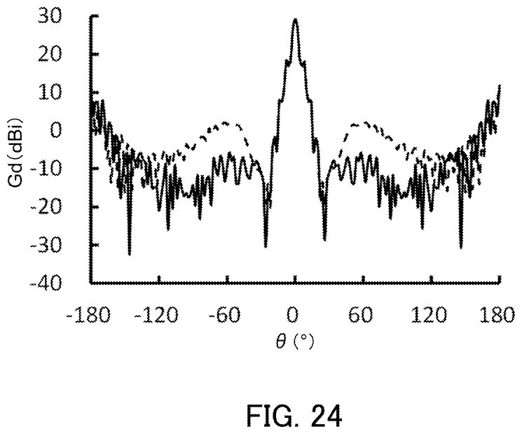

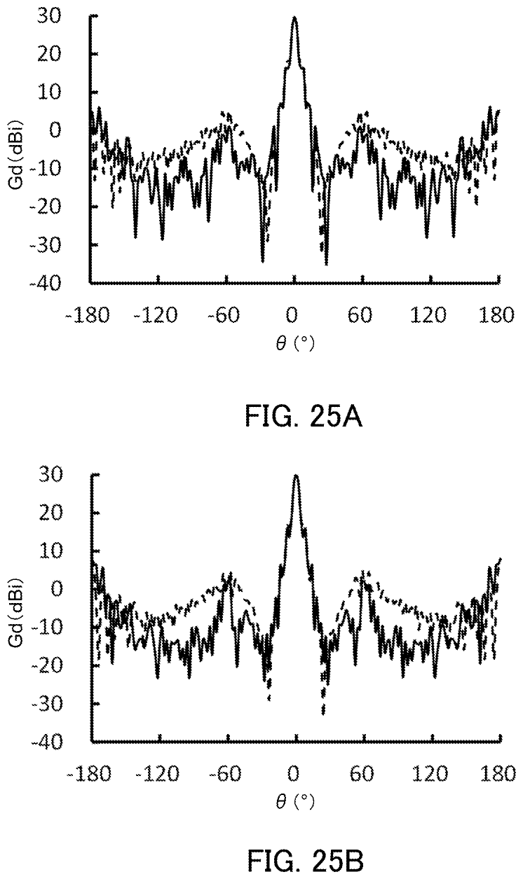

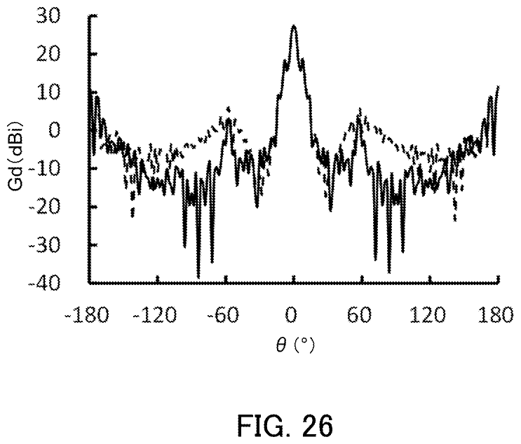

FIG. 23A is a graph illustrating an analysis result of a case where electromagnetic flux controlling member 400 of Embodiment 4 is used, and FIG. 23B is a graph illustrating an analysis result of a case where electromagnetic flux controlling member 500 of Embodiment 5 is used. FIG. 24 is a graph illustrating an analysis result of a case where electromagnetic flux controlling member 600 of Embodiment 6 is used. FIG. 25A is a graph illustrating an analysis result of a case where electromagnetic flux controlling member 700 of Embodiment 7 is used, and FIG. 25B is a graph illustrating an analysis result of a case where electromagnetic flux controlling member 800 of Embodiment 8 is used. FIG. 26 is a graph illustrating an analysis result of a case where electromagnetic flux controlling member 900 of Embodiment 9 is used. In FIGS. 23A to 26, the abscissa indicates the angle with respect to the reference line, and the ordinate indicates the antenna gain. In FIGS. 23A to 26, the solid line indicates the result in the XZ plane, and the broken line indicates the result in the YZ plane.

Table 2 shows the relationship between the type the electromagnetic flux controlling member used, the maximum gain, and the maximum gain power. Note that for comparison, a case where no electromagnetic flux controlling member is used (only a horn antenna is used) is also described.

TABLE 2

| Type of Electromagnetic | Maximum | Maximum |
|---|---|---|
| Flux Controlling Member | Gain | Gain Power |
| With horn antenna alone | 15.68 | 37.19 |
| Embodiment 4 | 30.15 | 1035.6 |
| Embodiment 5 | 30.28 | 1066.9 |
| Embodiment 6 | 29.17 | 827.5 |
| Embodiment 7 | 29.73 | 926.5 |
| Embodiment 8 | 30.15 | 1035.1 |
| Embodiment 9 | 27.50 | 562.9 |

FIG. 23A and Table 2 show that in the case where electromagnetic flux controlling member 400 of Embodiment 4 (width w2 of circular part 311 is 0.4 mm, width w1 of circular part 421 is 0.4 mm, and circular part 411 and circular part 421 coincide with each other) is used, the radio waves gather in the direction (the Z direction) from the radio wave source toward electromagnetic flux controlling member 400 in comparison with the case where only the horn antenna is used. In addition, in comparison with electromagnetic flux controlling member 1500 of reference example described later, the maximum gain and the maximum gain power were not substantially changed.

FIG. 23B and Table 2 show that in the case where electromagnetic flux controlling member 500 of Embodiment 5 (width w2 of circular part 411 is 0.4 mm, width w1 of circular part 421 is 0.4 mm, and the position of circular part 411 is shifted to central axis CA side with respect to circular part 421) is used, the radio waves gather in the direction from the radio wave source toward electromagnetic flux controlling member 400. Note that in comparison with electromagnetic flux controlling member 400 of Embodiment 4, the maximum gain and the maximum gain power were not substantially changed. In addition, in comparison with electromagnetic flux controlling member 1500 of reference example described later, the maximum gain and the maximum gain power were not substantially changed.

FIG. 24 and Table 2 show that in the case where electromagnetic flux controlling member 600 of Embodiment 6 (width w2 of circular part 411 is 0.4 mm, width w1 of circular part 421 is 0.4 mm, and the position of circular part 411 is shifted away from central axis CA side with respect to circular part 421) is used, the radio waves gather in the direction from the radio wave source toward electromagnetic flux controlling member 1200. Note that in comparison with electromagnetic flux controlling member 400 of Embodiment 4, the maximum gain and the maximum gain power were not substantially changed. In addition, in comparison with electromagnetic flux controlling member 1500 of reference example described later, the maximum gain and the maximum gain power were not substantially changed.

FIG. 25A and Table 2 show that in the case where electromagnetic flux controlling member 700 of Embodiment 7 (width w2 of circular part 411 is 0.8 mm, width w1 of circular part 421 is 0.8 mm, and circular part 711 and circular part 721 coincide with each other) is used, the radio waves gather in the direction from the radio wave source toward electromagnetic flux controlling member 700. Note that in comparison with electromagnetic flux controlling member 700 of Embodiment 7, the maximum gain and the maximum gain power were not substantially changed. In addition, in comparison with electromagnetic flux controlling member 1500 of reference example described later, the maximum gain and the maximum gain power were not substantially changed.

FIG. 25B and Table 2 show that in the case where electromagnetic flux controlling member 800 of Embodiment 8 (width w2 of circular part 411 is 0.8 mm, width w1 of circular part 421 is 0.8 mm, and the position of circular part 711 is shifted to central axis CA side with respect to circular part 721) is used, the radio waves gather in the direction from the radio wave source toward electromagnetic flux controlling member 800. Note that in comparison with electromagnetic flux controlling member 800 of Embodiment 8, the maximum gain and the maximum gain power were not substantially changed. In addition, in comparison with electromagnetic flux controlling member 1500 of reference example described later, the maximum gain and the maximum gain power were not substantially changed.

FIG. 26 and Table 2 show that in the case where electromagnetic flux controlling member 900 of Embodiment 9 (width w2 of circular part 411 is 0.8 mm, width w1 of circular part 421 is 0.8 mm, and the position of circular part 711 is shifted away from central axis CA with respect to circular part 721) is used, the maximum gain and the maximum gain power were reduced in comparison with electromagnetic flux controlling member 100 of Embodiment 1. In addition, in comparison with electromagnetic flux controlling member 1500 of reference example described later, the maximum gain and the maximum gain power were not substantially changed.

As FIGS. 23A to 26 and Table 2 show, in electromagnetic flux controlling members 400 to 900 of Embodiments 4 to 9, the characteristics of second regions 620, 720 and 820 are easily adjusted with the forming mold because the widths of circular parts 621, 721 and 821 are constant.

### Effects

With electromagnetic flux controlling members 400 to 900 of the present embodiment, electromagnetic flux controlling members 400 to 900 that can be manufactured with high yield can be provided while maintaining the function of electromagnetic flux controlling members 400 to 900. In addition, by providing electromagnetic flux controlling members 400 to 900 with a meniscus shape, the incident efficiency to electromagnetic waves electromagnetic flux controlling members 400 to 900 can be improved, and the increase of the thickness of the center portion of electromagnetic flux controlling members 400 to 900 can be suppressed. In addition, with the first region composed of the inner surface of a concave part, the reflection of the electromagnetic waves in the first region can be suppressed, and the electromagnetic waves can be prevented from being reflected in the first region to return to the transmission source.

### Embodiment 10

Next, electromagnetic flux controlling member 1000 according to Embodiment 10 is described.

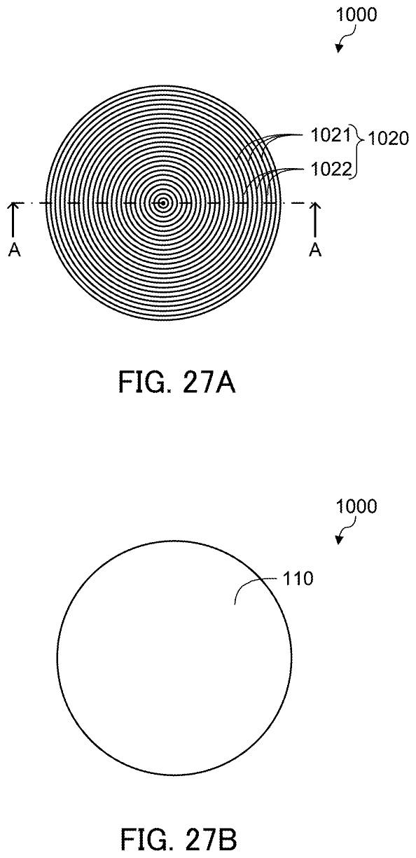

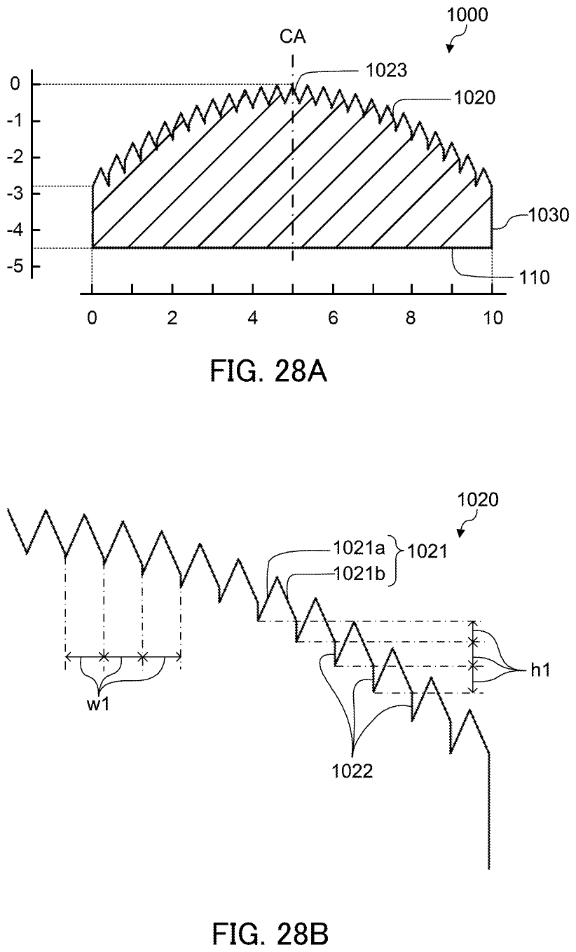

FIG. 27A is a plan view of electromagnetic flux controlling member 1000 according to Embodiment 10, and FIG. 27B is a bottom view. FIG. 28A is a cross-sectional view taken along line A-A of FIG. 27A, and FIG. 28B is a partially enlarged sectional view of FIG. 28A.

As illustrated in FIGS. 27A, 27B, 28A and 28B, electromagnetic flux controlling member 1000 according to Embodiment 10 includes first region 110 and second region 1020. Electromagnetic flux controlling member 1000 according to the present embodiment further includes side surface 1030.

In the present embodiment, first region 110 is a flat surface.

Second region 1020 includes a plurality of circular parts 1021, a plurality of first step surfaces 1022, and apex 1023.

The plurality of circular parts 1021 is optical surfaces with a circular shape concentrically disposed in plan view. In addition, apex 1023 with a cone shape is disposed at a center portion of second region 1020. In the present embodiment, circular part 1021 includes third surface 1021a disposed inside and fourth surface 1021b disposed outside electromagnetic flux controlling member 1000. Third surface 1021a is tilted toward the front side as it goes toward the outside of electromagnetic flux controlling member 1000, and fourth surface 1021b is tilted toward the rear side as it goes toward the outside of electromagnetic flux controlling member 1000. In the present embodiment, the heights (the distance in the Z direction) of the inner edge of third surface 1021a and the outer edge of fourth surface 1021b are the same. In the cross section including central axis CA, the shape of circular part 1021 may be a triangular shape or a trapezoidal shape. In the present embodiment, the shape of circular part 1021 in the cross section including central axis CA is an isosceles triangle. In the present embodiment, the shape of circular part 1021 is a shape of a triangular ridge. Specifically, in the present embodiment, circular part 1021 functions as an alignment layer.

The outer edges of the plurality of circular parts 1021 are disposed to come closer to the rear side with increasing distance from central axis CA. Specifically, in the present embodiment, the plurality of circular parts 1021 is disposed stepwise such that the height of first region 110 decreases with increasing distance from central axis CA. In the cross section including central axis CA, widths w1 of the plurality of circular parts 1021 (the distance of the inner edge of third surface 1021a and the outer edge of fourth surface 1021b in plan view) are constant, and are smaller than the wavelength of the electromagnetic waves used. Preferably, the distance (pitch) between the outer edges of circular parts 1021 adjacent to each other in plan view is within a range of 0.2 to 1.0 mm. In the present embodiment, widths w1 (pitch) of the plurality of circular parts 1021 with a circular shape are 0.4 mm. In addition, the diameter of the top surface is 0.4 mm.

First step surface 1022 is a curved surface disposed to surround central axis CA, and connects two circular parts 1021 adjacent to each other. Circular part 1021 is connected to the upper end and lower end of first step surface 1022. Fourth surface 1021b is connected to the upper end of first step surface 1022, and third surface 1021a is connected to the lower end of first step surface 1022. The shape of first step surface 1022 may be a shape of the side surface of a column, or a shape of the side surface of a truncated cone. Specifically, first step surface 1022 may be parallel to central axis CA, or tilted to central axis CA. In the present embodiment, first step surface 1022 is parallel to central axis CA. Height h1 of first step surface 1022 is set to increase in the direction from the front side (center portion) toward the rear side (side surface side) of electromagnetic flux controlling member 1000.

Side surface 1030 is a curved surface disposed to surround central axis CA, and connects the outer edge of first region 110 and the outer edge of second region 1020. The shape of side surface 1030 is not limited. In the present embodiment, the shape of side surface 1030 is a shape of the side surface of a column. First region 110 is connected to the lower end portion (rear side) of side surface 1030, and second region 1020 is connected to the upper end portion (front side). In the present embodiment, the height of side surface 1030 is 2.5 mm. Note that electromagnetic flux controlling member 1000 may not include side surface 1030. In this case, first region 110 and second region 1020 are directly connected to each other.

### Embodiment 11

Next, electromagnetic flux controlling member 1100 of Embodiment 11 is described. Electromagnetic flux controlling member 1100 of the present embodiment is different from electromagnetic flux controlling member 100 according to Embodiment 1 only in the shape of second region 1120. In view of this, the same components as those of electromagnetic flux controlling member 100 of Embodiment 1 are denoted with the same reference numerals, and the description thereof will be omitted.

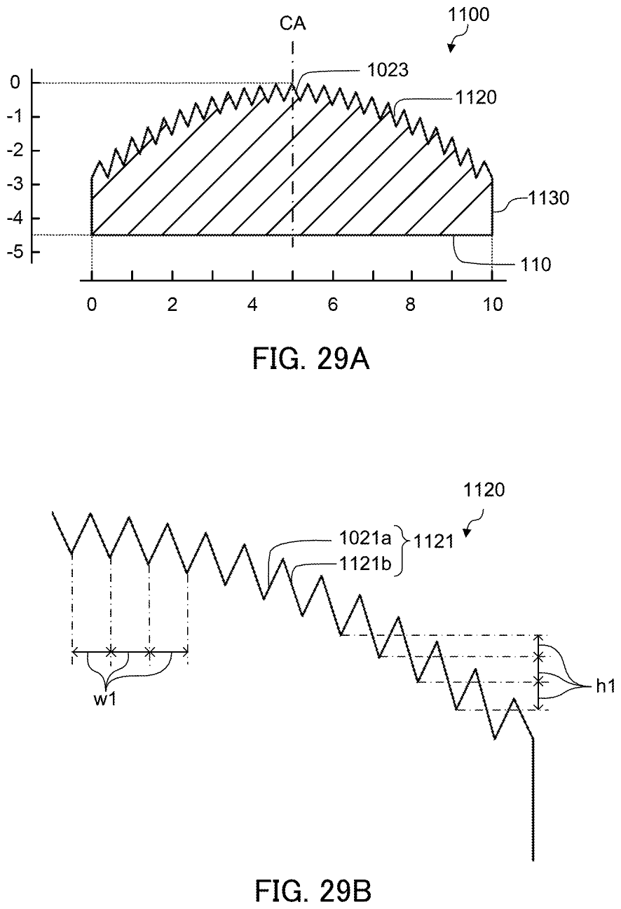

FIG. 29A is a sectional view of electromagnetic flux controlling member 1100 of Embodiment 11, and FIG. 29B is a partially enlarged sectional view of FIG. 29A.

As illustrated in FIGS. 29A and 29B, electromagnetic flux controlling member 1100 of Embodiment 11 includes first region 110 and second region 1120. Electromagnetic flux controlling member 1100 according to the present embodiment further includes side surface 1130.

In the present embodiment, first region 110 is a flat surface.

Second region 1120 includes a plurality of circular parts 1121, and apex 1023. That is, second region 1120 of the present embodiment does not include the first step surface. The plurality of circular parts 1121 are concentric circular optical surfaces. In addition, apex 1023 with a cone shape is disposed at a center portion of second region 1120. In the present embodiment, circular part 1121 includes third surface 1021a disposed inside and fourth surface 1121b disposed outside electromagnetic flux controlling member 100. Third surface 1021a is tilted toward the front side as it goes toward the outside of electromagnetic flux controlling member 1100, and fourth surface 1121b is tilted toward the rear side as it goes toward the outside of electromagnetic flux controlling member 1100. In the present embodiment, the height of the inner edge of third surface 1021a and the height (the distance in the Z direction) of the outer edge of fourth surface 1121b are different from each other. More specifically, the heights of a plurality of third surfaces 1021a are constant. The heights of a plurality of fourth surfaces 1121b are different from each other. In the present embodiment, the inner edge of fourth surface 1121b is connected to the outer edge of third surface 1021a. In addition, the outer edge of fourth surface 1121b is connected to the inner edge of fourth surface 1121b of circular part 1121 adjacent thereto on the outside. In the present embodiment, the shape of circular part 1121 is a triangular shape in the cross section including central axis CA.

The outer edges of the plurality of circular parts 1121 are disposed to come closer to the rear side with increasing distance from central axis CA. Specifically, in the present embodiment, the plurality of circular parts 1121 is disposed stepwise such that the height of first region 110 decreases with increasing distance from central axis CA. Widths w1 of at least some of circular parts 1121 (the distance between the inner edge of third surface 1021a and the outer edge of fourth surface 1121b) are the same, and are smaller than the wavelength of the electromagnetic waves used. Preferably, the distance (pitch) between the outer edges of circular parts 1121 adjacent to each other is within a range of 0.2 to 1.0 mm. In the present embodiment, width w1 (pitch) of the plurality of circular parts 1121 with a circular shape is 0.4 mm. In addition, the diameter in plan view of apex 1023 is 0.4 mm.

Side surface 1130 is a curved surface disposed to surround central axis CA and connects the outer edge of first region 110 and the outer edge of second region 1120. The shape of side surface 1130 is not limited. In the present embodiment, the shape of side surface 1130 is a shape of the side surface of a column. First region 110 is connected to the lower end portion (rear side) of side surface 1130, and second region 1020 is connected to the upper end portion (front side). Note that electromagnetic flux controlling member 1100 may not include side surface 1130. In this case, first region 110 and second region 1120 are directly connected to each other.

### Embodiment 12

Next, electromagnetic flux controlling member 1200 of Embodiment 12 is described. Electromagnetic flux controlling member 1200 of the present embodiment is different from electromagnetic flux controlling member 100 according to Embodiment 1 only in the shape of second region 1220. In view of this, the same components as those of electromagnetic flux controlling member 100 of Embodiment 1 are denoted with the same reference numerals, and the description thereof will be omitted.

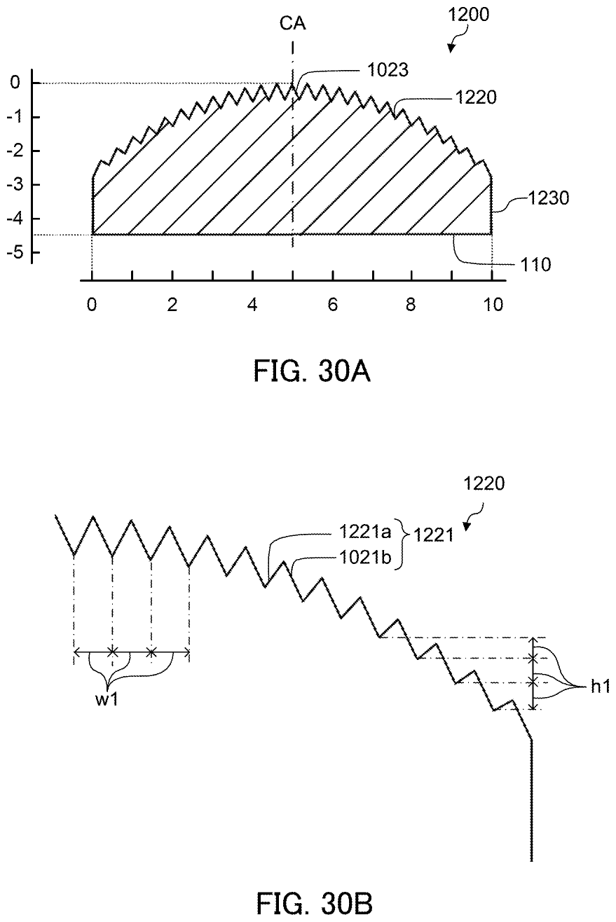

FIG. 30A is a sectional view of electromagnetic flux controlling member 1200 of Embodiment 12, and FIG. 30B is a partially enlarged sectional view of FIG. 30A.

As illustrated in FIGS. 30A and 30B, electromagnetic flux controlling member 1200 of Embodiment 12 includes first region 110 and second region 1220. Electromagnetic flux controlling member 1200 according to the embodiment further includes side surface 1230.

In the present embodiment, first region 110 is a flat surface.

Second region 1220 includes a plurality of circular parts 1221, and apex 1023. That is, second region 1220 of the present embodiment does not include the first step surface.

The plurality of circular parts 1221 is optical surfaces with a circular shape concentrically disposed in plan view. In addition, apex 1023 with a cone shape is disposed at a center portion of second region 1220. In the present embodiment, circular part 1221 includes third surface 1221a disposed inside and fourth surface 1021b disposed outside electromagnetic flux controlling member 1200. Third surface 1221a is tilted toward the front side as it goes toward the outside of electromagnetic flux controlling member 1200, and fourth surface 1021b is tilted toward the rear side as it goes toward the outside of electromagnetic flux controlling member 1200. In the present embodiment, the height of the inner edge of third surface 1221a and the height (the distance in the Z direction) of the outer edge of fourth surface 1021b are different from each other. More specifically, the heights of a plurality of third surface 1221a are different from each other. The heights of a plurality of fourth surfaces 1021b are constant. In the present embodiment, the inner edge of fourth surface 1021b is connected to the outer edge of third surface 1221a. In addition, the outer edge of fourth surface 1021b is connected to the inner edge of fourth surface 1021b of circular part 1221 adjacent thereto on the outside. In the present embodiment, the shape of circular part 1221 is a triangular shape in the cross section including central axis CA.

The outer edges of the plurality of circular parts 1221 are disposed to come closer to the rear side with increasing distance from central axis CA. Specifically, in the present embodiment, the plurality of circular parts 1221 is disposed stepwise such that the height of first region 110 decreases with increasing distance from central axis CA. Widths w1 of at least some of circular parts 1221 (the distance between the inner end portion of third surface 1221a and the outer edge of fourth surface 1021b) are the same, and are smaller than the wavelength of the electromagnetic waves used. Preferably, the distance (pitch) between the outer edges of circular parts 1221 adjacent to each other is within a range of 0.2 to 1.0 mm. In the present embodiment, width w1 (pitch) of the plurality of circular parts 1221 with a circular shape is mm. In addition, the diameter in plan view of the apex is 0.4 mm.

Side surface 1230 is a curved surface disposed to surround central axis CA, and connects the outer edge of first region 110 and the outer edge of second region 1220. The shape of side surface 1230 is not limited. In the present embodiment, the shape of side surface 1230 is a shape of the side surface of a cylinder. First region 110 is connected to the lower end portion (rear side) of side surface 1230, and second region 1220 is connected to the upper end portion (front side). Note that electromagnetic flux controlling member 1200 may not include side surface 1230. In this case, first region 110 and second region 1220 are directly connected to each other.

Note that although the results are not shown, the maximum gain and the maximum gain power were not substantially changed even when electromagnetic flux controlling members 1000 to 1200 of Embodiments 10 to 12 were used.

### Effects

As described above, electromagnetic flux controlling members 1000 to 1200 according to the present embodiment have an effect similar to that of electromagnetic flux controlling member 100 of Embodiment 1.

Note that while the first region is the incidence region for allowing the incidence of electromagnetic waves, and the second region is the emission region for emitting to the outside electromagnetic waves in Embodiments 1 to 12, the first region and the second region may be the emission region and the incidence region, respectively. Note that also in this case, the maximum gain and the maximum gain power were not substantially changed although the results are not shown.

### Reference Examples

Next, electromagnetic flux controlling member 1500 according to a reference example is described. In electromagnetic flux controlling member 1500 according to the reference example, first region 1510 and second region 1520 do not have a step shape.

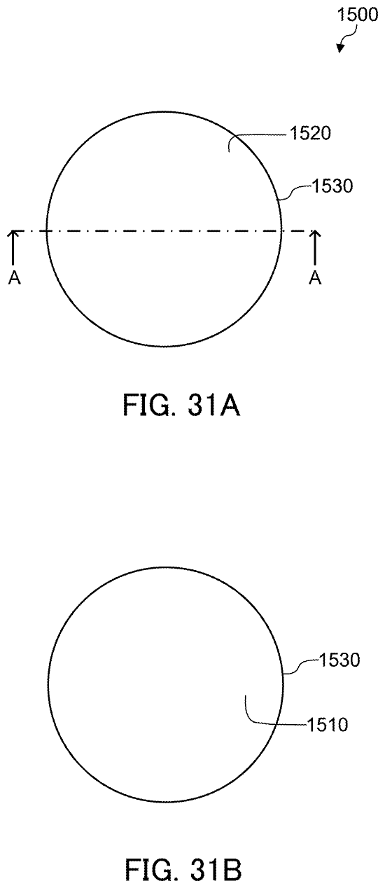

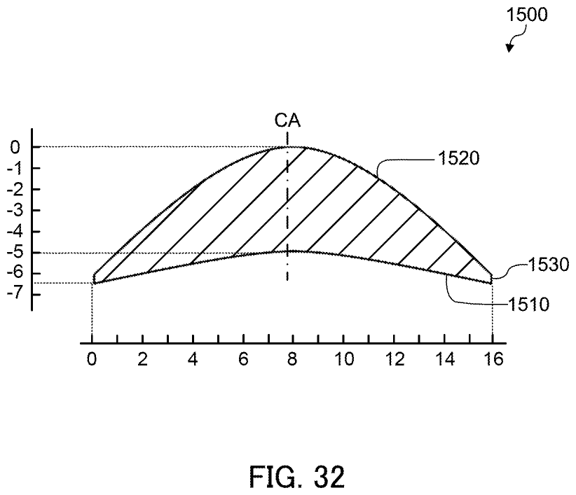

FIG. 31A is a plan view of electromagnetic flux controlling member 1500 according to a reference example, and FIG. 31B is a bottom view. FIG. 32 is a sectional view taken along line A-A of FIG. 31A.

As illustrated in FIGS. 31A, 31B and 32, electromagnetic flux controlling member 1500 according to the reference example includes first region 1510 and second region 1520. Note that electromagnetic flux controlling member 1500 of reference example further includes side surface 1530.

The material of electromagnetic flux controlling member 1500 of is not limited as long as the effects of the present invention can be achieved, and is appropriately selected from materials that allow the electromagnetic waves to be controlled to pass therethrough. Examples of the material of electromagnetic flux controlling member 1500 include ceramics, resin materials and glass. Examples of the resin material include polypropylene, polycycloolefin, polytetrafluoroethylene, and modified polyphenylene ether. Preferably, the material of electromagnetic flux controlling member 100 is a material with a high dielectric constant with a relative permittivity of 5 or greater because significant effects can be achieved, for example. Note that in the present embodiment, electromagnetic flux controlling member 1500 is rotationally symmetrical (circularly symmetrical) about central axis CA as the rotation axis. Note that in the present embodiment, electromagnetic flux controlling member 1500 has a height of 6.5 mm, and a diameter in plan view of 16 mm.

The type of the electromagnetic waves to be controlled is not limited. Examples of the electromagnetic waves include radio waves such as millimeter waves, quasi-millimeter waves, visible light beams, and infrared rays.

First region 1510 is a region for allowing incidence of the electromagnetic waves. First region 1510 is disposed to intersect central axis CA of electromagnetic flux controlling member 1500.

The shape of first region 1510 is not limited as long as it can allow incidence of electromagnetic waves. In the present embodiment, the shape of first region 1510 is rotationally symmetrical about central axis CA of electromagnetic flux controlling member 1500. First region 1510 may be a flat surface or a concave surface, or a plurality of convex parts may be provided. In the present embodiment, the shape of first region 1510 is the inner surface of a concave part with no step.

The shape of the concave part is not limited as long as no step is provided. In the present embodiment, the inner surface of the concave part is formed such that the height of its bottom portion is located above the outermost part of second region 1520. In addition, in the direction along central axis CA, the distance of first region 1510 and second region 1520 is shorter on the outer edge side than on the central axis CA side. Note that in the present embodiment, the height of first region 1510 is 1.5 mm.

Second region 1520 is a region for emitting, to the outside of electromagnetic flux controlling member 1500, the electromagnetic waves entered from first region 1510, while controlling the travelling direction. Second region 1520 is disposed to intersect central axis CA of electromagnetic flux controlling member 1500 with a convex shape in its entirety. In the present embodiment, second region 1520 is formed such that its outer edge is located on the lower side than the bottom portion of the concave part. Note that in the present embodiment, the height of second region 1520 is 6.0 mm.

Side surface 1530 is a curved surface disposed to surround central axis CA, and connects the outer edge of first region 1510 and the outer edge of second region 1520. The shape of side surface 1530 is not limited. In the present embodiment, the shape of side surface 1530 is a shape of the side surface of a cylinder. First region 1510 is connected to the lower end portion (rear side) of side surface 1530, and second region 1520 is connected to the upper end portion (front side). In the present embodiment, the height of side surface 1530 is 0.5 mm. Note that electromagnetic flux controlling member 1500 may not include side surface 1530. In this case, first region 1510 and second region 1520 are directly connected to each other.

### Simulations

Next, in the present embodiment, the relationship between the angle with respect to the reference line, and the maximum gain and the maximum gain power was examined.

The condition of the simulation is the same as in Embodiment 1, and therefore the description thereof will be omitted. The maximum gain of electromagnetic flux controlling member 1500 according to the reference example is 30.21 dBi, and the maximum gain power is 1049.2.

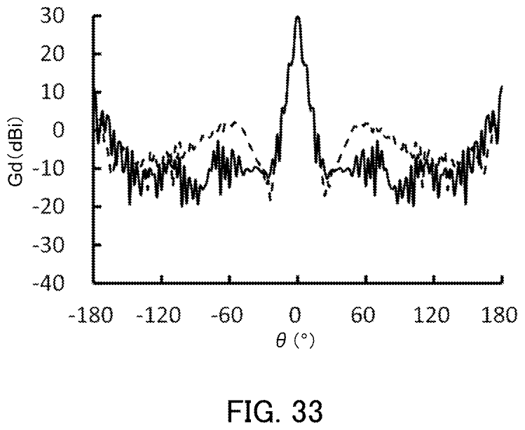

FIG. 33 shows that in the case where electromagnetic flux controlling member 1500 according to the reference example is used, the radio waves gather in the direction (the Z direction) from the radio wave source toward electromagnetic flux controlling member 1500 in comparison with the case where only the horn antenna is used.

### Effects

With electromagnetic flux controlling member 1500 of the present embodiment, electromagnetic flux controlling member 1500 that can be manufactured with high yield can be provided while maintaining the function of electromagnetic flux controlling member 1500.

### INDUSTRIAL APPLICABILITY

The electromagnetic flux controlling member of the present invention is useful for radio communication and optical fields.

### REFERENCE SIGNS LIST

10. Horn antenna
100, 200, 300, 400, 500, 600, 700, 800, 900, 1000, 1100, 1200, 1500, 2100, 2200, 2300, 2400, 2500 Electromagnetic flux controlling member
110, 410, 510, 610, 710, 810, 1510 First region
120, 220, 320, 420, 520, 620, 720, 920, 1020, 1120, 1220, 1520, 2120, 2220, 2320, 2420, 2520 Second region
121, 221, 321, 421, 621, 721, 821, 1021, 1121, 1221, 2321, 2421, 2521 Circular part
122, 222, 322, 422, 622, 722, 822, 1022, 2322, 2422, 2522 First step surface
123, 223, 423, 623, 723, 923, 2323, 2523 Top surface
130, 430, 530, 630, 730, 830, 1030, 1130, 1230, 1530 Side surface
150, 450, 1050 Forming mold
160, 460 First forming mold
161, 461 First transfer surface
170, 470 Second forming mold
171, 471 Second transfer surface
180, 480 Third forming mold
181, 481 Third transfer surface
182, 482 Third forming piece
183, 483 Fourth forming piece
184, 484 Transfer surface
190, 490 Cavity
311, 411, 511, 711, 811 Circular part
412, 712, 1012 Second step surface
413, 513, 713, 813 Bottom surface
462 First forming piece
464 Fifth forming piece
465 First transfer surface
1021a, 1221a Third surface
1021b, 1121b, 2021b Fourth surface
1023 Apex
CA Central axis

What is claimed is:

1. An electromagnetic flux controlling member comprising:
a first region disposed on a rear side, and configured to allow incidence of electromagnetic waves or to emit to outside electromagnetic waves having travelled inside; and
a second region disposed on a front side, and configured to emit to the outside the electromagnetic waves entered from the first region or to allow incidence of electromagnetic waves,
wherein the second region includes a plurality of circular parts on a second region side concentrically disposed in plan view,
wherein outer edges of the plurality of circular parts on the second region side are disposed such that the outer edges of the plurality of circular parts on the second region side come closer to the rear side with increasing distance from a central axis side, and
wherein widths of at least some circular parts adjacent to each other on the second region side among the plurality of circular parts on the second region side are the same, and are smaller than a wavelength of the electromagnetic waves.

2. The electromagnetic flux controlling member according to claim 1, wherein widths of the plurality of circular parts on the second region side other than a circular part on the second region side that is farthest from the central axis among the plurality of circular parts on the second region side are the same.

3. The electromagnetic flux controlling member according to claim 1, wherein widths of the plurality of circular parts on the second region side are within a range equal to or greater than 0.2 mm, and are smaller than 1.1 mm.

4. The electromagnetic flux controlling member according to claim 1, wherein each of the plurality of circular parts on the second region side includes a ridgeline.

5. The electromagnetic flux controlling member according to claim 1, wherein the plurality of circular parts on the second region side is disposed such that a difference in height of outer edges of two circular parts on the second region side adjacent to each other among the plurality of circular parts on the second region side increases with increasing distance from the central axis.

6. The electromagnetic flux controlling member according to claim 1,
wherein the first region includes a plurality of circular parts on a first region side concentrically disposed in plan view, and
wherein outer edges of the plurality of circular parts on the first region side are disposed such that the outer edges of the plurality of circular parts on the first region side come closer to the rear side with increasing distance from the central axis.

7. The electromagnetic flux controlling member according to claim 6, wherein in plan view, the outer edges of the plurality of circular parts on the second region side and the outer edges of the plurality of circular parts on the first region side overlap each other.

8. The electromagnetic flux controlling member according to claim 6, wherein an area of a region inside an innermost circular part on the second region side among the plurality of circular parts on the second region side is greater than an area of a region inside an innermost circular part on the first region side among the plurality of circular parts on the first region side.

9. A manufacturing method for the electromagnetic flux controlling member according to claim 1, the method comprising:
forming the plurality of circular parts on the second region side by using a forming mold,
wherein the forming mold includes a plurality of forming pieces with a cylindrical shape concentrically disposed, and
wherein each of the plurality of forming pieces includes a transfer surface with a circular shape in plan view for forming some of the plurality of circular parts on the second region side.

10. The manufacturing method for the electromagnetic flux controlling member according to claim 9, wherein each of the plurality of forming pieces includes a transfer surface with a circular shape in plan view for forming one of the plurality of circular parts on the second region side.
